(19) United States
(12) Patent Application Publication
(10) Pub. No.: US 2022/0148028 A1
(43) Pub. Date: May 12, 2022

(54) INFORMATION PROCESSING DEVICE AND INFORMATION PROCESSING METHOD

(71) Applicant: KDDI CORPORATION, Shinjuku-ku, Tokyo (JP)

(72) Inventors: Haruka SHIMIZU, Tokyo (JP); Naoya KADOWAKI, Tokyo (JP)

(73) Assignee: KDDI CORPORATION, Shinjuku-ku, Tokyo (JP)

(21) Appl. No.: 17/433,851

(22) PCT Filed: Mar. 6, 2020
(86) PCT No.: PCT/JP2020/009598

§ 371 Date: Aug. 25, 2021

(30) Foreign Application Priority Data
Mar. 20, 2019 (JP) 2019-052272
Mar. 20, 2019 (JP) 2019-052273

(51) Int. Cl. G06Q 30/02; G06Q 20/38

(52) U.S. Cl. CPC G06Q 30/0236; G06Q 30/0224; G06Q 20/38215

(57) ABSTRACT

A privilege provision device according to an embodiment of the present invention includes a payment token request reception unit configured to receive a token request including user identification information from a user terminal, a token generation unit configured to generate a token associated with coupon identification information and the user identification information, a token transmission unit configured to transmit the token to the user terminal, a payment request reception unit configured to receive a payment request including the token from a store terminal, a validity determination unit configured to determine whether or not a coupon associated with the coupon identification information is valid at the time of the reception of the token request, and a privilege provision unit configured to provide the user with a privilege by the coupon associated with the coupon identification information corresponding to the token is in a case where the validity determination unit determines that the coupon is valid.

### TECHNICAL FIELD

The present invention relates to an information processing device and an information processing method that make payment using a coupon.

Priority is claimed on Japanese Patent Application Nos. 2019-52272 and 2019-52273, filed Mar. 20, 2019, the contents of which are incorporated herein by reference.

### BACKGROUND ART

In the related art, a system is known in which a store terminal provided in a store reads a code of a coupon displayed on a user terminal of a user, and if the coupon is applicable, a discount is given for the price of a product (for example, see Patent Document 1).

### PRIOR ART DOCUMENTS

### Patent Document

[Patent Document 1]

Japanese Unexamined Patent Application, First Publication No. 2002-260099

### SUMMARY OF INVENTION

### Problems to be Solved by the Invention

In the system described in Patent Document 1, a host computer that manages the store terminal distributes a coupon to the user terminal, and the store terminal reads the coupon and determines applicability.

A case where the system described in Patent Document 1 is configured such that the user terminal reads a coupon display on the store terminal is also considered. In this case, the store terminal needs to display the coupon after determining the applicability of the coupon.

For this reason, a burden for processing of determining the applicability of the coupon is imposed on the store terminal. Furthermore, a large burden for managing information regarding the coupon on the store terminal and the host computer is imposed to a manager of the store.

The present invention has been accomplished in view of the above-described point, and an object of the present invention is to reduce the burden on a store in a system in which a store terminal reads a coupon displayed on a user terminal in making payment of the price of a product.

### Means for Solving the Problems

An information processing device according to a first aspect of the present invention includes a first reception unit configured to receive a token request including user identification information from a user terminal used by a user, a generation unit configured to generate a token associated with coupon identification information associated with a coupon given to the user associated with the user identification information and the user identification information included in the token request, a transmission unit configured to transmit the token generated by the generation unit to the user terminal, a second reception unit configured to receive a payment request including the token acquired from the user terminal by a store terminal provided in a store, from the store terminal, a determination unit configured to determine whether or not the coupon associated with the coupon identification information is valid at the time of the reception of the token request, and a privilege provision unit configured to provide the user associated with the user identification information corresponding to the token with a privilege by the coupon associated with the coupon identification information corresponding to the token in a case where the determination unit determines that the coupon is valid.

An information processing method that is executed by a processor according to a second aspect of the present invention includes receiving a token request including user identification information from a user terminal used by a user, generating a token associated with coupon identification information associated with a coupon given to the user associated with the user identification information and the user identification information included in the token request, transmitting the token generated in the generating step to the user terminal, receiving a payment request including the token acquired from the user terminal by a store terminal provided in a store from the store terminal, determining whether or not the coupon associated with the coupon identification information is valid at the time of the reception of the token request, and providing the user associated with the user identification information corresponding to the token with a privilege by the coupon associated with the coupon identification information corresponding to the token in a case where determination is made in the determining step that the coupon is valid.

An information processing device according to a third aspect of the present invention includes a first reception unit configured to receive a coupon application request including user identification information from a user terminal used by a user, a second reception unit configured to receive a payment request including at least one of the user identification information and coupon identification information associated with a coupon given to the user associated with the user identification information from the user terminal that reads a payment code in a store, a determination unit configured to determine whether or not the coupon associated with the coupon identification information is valid at the time of the reception of the coupon application request, and a privilege provision unit configured to provide the user associated with the user identification information with a privilege by the coupon associated with the coupon identification information in a case where the determination unit determines that the coupon is valid.

An information processing method that is executed by a processor according to a fourth aspect of the present invention includes receiving a coupon application request including user identification information from a user terminal used by a user, receiving a payment request including at least one of the user identification information and coupon identification information associated with a coupon given to the user associated with the user identification information from the user terminal that reads a payment code in a store, determining whether or not the coupon associated with the coupon identification information is valid at the time of the reception of the coupon application request, and providing the user associated with the user identification information with a privilege by the coupon associated with the coupon identification information in a case where determination is made in the determining step that the coupon is valid.

### Advantageous Effects of the Invention

According to the present invention, in a system in which a store terminal reads a coupon displayed on a user terminal in making payment of the price of a product, an effect capable of reducing a burden on a store is obtained.

### BRIEF DESCRIPTION OF DRAWINGS

FIG. 1 is a schematic view showing a payment system according to a first embodiment.

FIG. 2 is a block diagram showing a privilege provision device according to the first embodiment.

FIG. 3 is a block diagram showing a user terminal and a store terminal according to the first embodiment.

FIG. 4A is a table showing coupon information according to the first embodiment.

FIG. 4B is a table showing token information according to the first embodiment.

FIG. 5A is a front view showing the user terminal that displays a payment screen according to the first embodiment.

FIG. 5B is a front view showing the user terminal that displays a coupon selection screen according to the first embodiment.

FIG. 6A is a front view showing the user terminal that displays a payment screen according to the first embodiment.

FIG. 6B is a front view showing the user terminal that displays a payment screen according to the first embodiment.

FIG. 7 is a sequence diagram showing a payment method that is executed by the payment system according to the first embodiment.

FIG. 8 is a sequence diagram showing a payment method according to a modification example of the first embodiment.

FIG. 9 is a schematic view showing a payment system according to a second embodiment.

FIG. 10 is a block diagram showing a privilege provision device according to the second embodiment.

FIG. 11 is a block diagram showing a user terminal and a store terminal according to the second embodiment.

FIG. 12A is a table showing coupon information according to the second embodiment.

FIG. 12B is a table showing token information according to the second embodiment.

FIG. 12C is a table showing validity information according to the second embodiment.

FIG. 13 is a front view showing a display unit of the store terminal that displays a payment screen according to the second embodiment.

FIG. 14 is a front view showing the user terminal that displays a coupon selection screen according to the second embodiment.

FIG. 15A is a front view showing the user terminal that displays a code reading screen according to the second embodiment.

FIG. 15B is a front view showing the user terminal that displays a code reading screen according to the second embodiment.

FIG. 16 is a sequence diagram showing a payment method that is executed by the payment system according to the second embodiment.

FIG. 17 is a sequence diagram showing a payment method according to a modification example of the second embodiment.

FIG. 18 is a sequence diagram showing a payment method according to another modification example of the second embodiment.

### DESCRIPTION OF EMBODIMENTS

### First Embodiment

### [Outline of Payment System 1S]

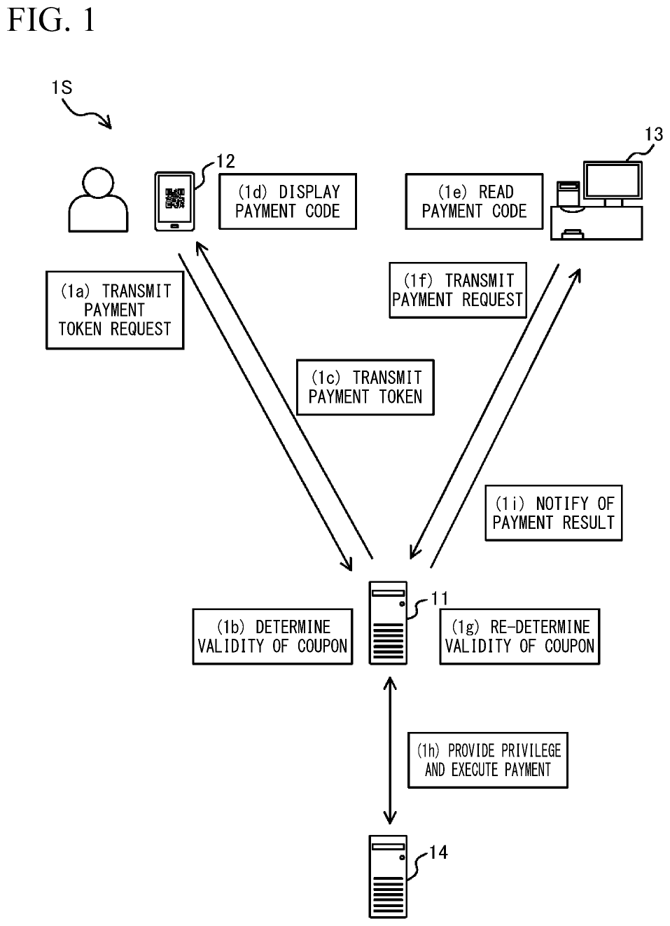

FIG. 1 is a schematic view of a payment system 1S (information processing system) according to a first embodiment. The payment system 1S includes a privilege provision device 11, a user terminal 12, a store terminal 13, and a payment server 14. The payment system 1S may include equipment, such as other server or terminal.

The privilege provision device 11 (information processing device) is a computer that determines validity of an electronic coupon given to a user and provides the user with a privilege by the coupon. The user is a customer of a store, such as a retail store. The privilege provision device 11 can perform communication with the user terminal 12, and the store terminal 13 and the payment server 14 through a network, such as the Internet or a local area network.

The user terminal 12 is a computer that receives a user's operation and displays various kinds of information. The user terminal 12 is, for example, a portable terminal, such as a smartphone or a tablet terminal. The store terminal 13 is a computer that is provided in the store, reads information of a product purchased by the user, and reads a payment code presented by the user. The store terminal 13 is, for example, a point of sale (POS) terminal or a communication terminal provided to a salesclerk of the store. The payment server 14 is a computer that makes payment of the price of the product purchased by the user. The product is an article or a service that can be purchased by the user through payment of a price.

The outline of processing in which the payment system 1S according to the first embodiment applies a coupon to make payment will be described. The privilege provision device 11 gives a coupon to the user in advance and stores a user ID for identifying the user and a coupon ID for identifying the coupon in a storage unit in association with each other. The user ID may be allocated to each user or may be allocated to each user terminal 12. The user uses the coupon at the time of purchase of a product, and accordingly, the coupon provides the user with a predetermined privilege. The privilege by the coupon is, for example, a discount of a price of a product, an offer of a gift, an award of points, or the like. The user can purchase a product using the coupon given to the user at a desired timing.

The user performs an operation to select a coupon that the user wants to use, on the user terminal 12 of the user before purchasing a product in a store. The user terminal 12 transmits a payment token request including the user ID associated with the user terminal 12 and the coupon ID associated with the selected coupon to the privilege provision device 11 (1a).

The privilege provision device 11 determines whether or not the coupon is valid based on the user ID and the coupon ID included in the received payment token request (1b). In this case, the privilege provision device 11 determines the validity of the coupon, for example, based on the presence or absence of the coupon, the availability of the coupon, and the term of validity of the coupon. In a case where the payment token request is received, the privilege provision device 11 generates a payment token. In this case, the privilege provision device 11 stores the coupon ID and the token in the storage unit in association with each other.

The privilege provision device 11 transmits the generated payment token to the user terminal 12 as a transmission source of the payment token request (1c). The user terminal 12 generates a payment code based on the received payment token and displays the payment code on a display unit (1d). The payment code is a text string or an image that is readable by the store terminal 13. The user presents the payment code displayed on the user terminal 12 to the store terminal 13 in purchasing the product in the store.

The store terminal 13 reads the payment code displayed on the user terminal 12 using an imaging unit (1e). The store terminal 13 acquires the payment token indicated by the payment code by decoding the read payment code. The store terminal 13 transmits a payment request including payment information including a payment amount of the product purchased by the user and the payment token indicated by the read payment code, to the privilege provision device 11 (1f). The privilege provision device 11 searches for the payment token included in the received payment request from the storage unit.

In a case where the payment token included in the received payment request is found on the storage unit, the privilege provision device 11 specifies the coupon ID corresponding to the payment token. The privilege provision device 11 re-determines whether or not the coupon of the specified coupon ID is valid (1g). In this case, the privilege provision device 11 determines the validity of the coupon, for example, based on the presence or absence of the coupon, the availability of the coupon, the term of validity of the coupon, and a store ID for identifying the store.

In a case where determination is made that the coupon of the coupon ID corresponding to the payment token is valid, the privilege provision device 11 provides the user with the privilege by the coupon and transmits the payment amount of the payment information included in the received payment request to the payment server 14 in association with the user ID (1h). Here, in a case where the privilege by the coupon is a discount, the privilege provision device 11 subtracts a discount amount by the coupon from the payment amount and transmits a result to the payment server 14.

The payment server 14 executes payment processing in a case where the payment amount received from the privilege provision device 11 is within a balance (for example, a credit balance or a pre-paid balance) payable by the user and does not execute the payment processing otherwise. The payment server 14 transmits a payment result indicating whether or not payment is made, to the privilege provision device 11. The privilege provision device 11 notifies the store terminal 13 of the payment result received from the payment server 14 (1i).

In this way, in the payment system 1S according to the first embodiment, instead of the store terminal 13, the privilege provision device 11 executes the processing of determining the validity of the coupon and the processing of applying the coupon. With this, it is possible to reduce a processing burden on the store terminal 13, and there is no need for costs to improve the processing performance of the store terminal 13. Furthermore, since a manager of the store does not need to register information of the coupon in the store terminal 13, it is possible to reduce a management burden on the manager of the store.

### [Configuration of Payment System 1S]

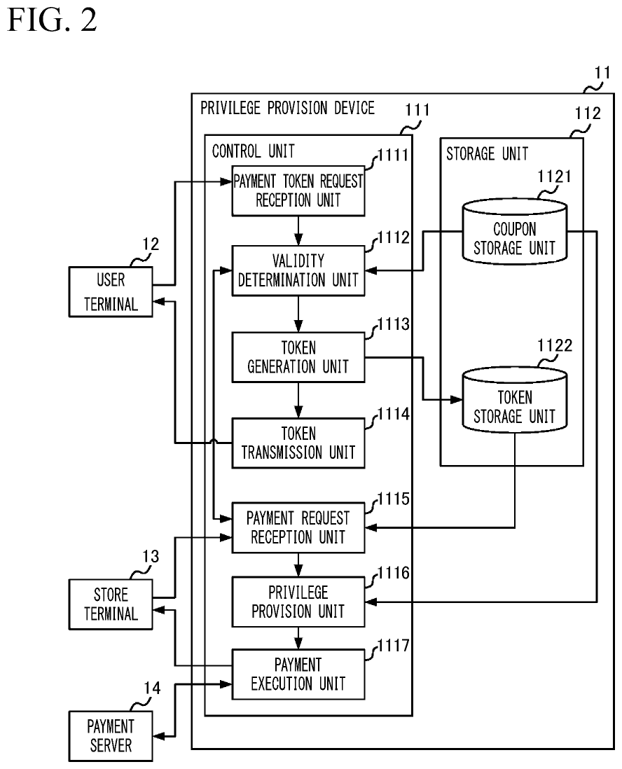

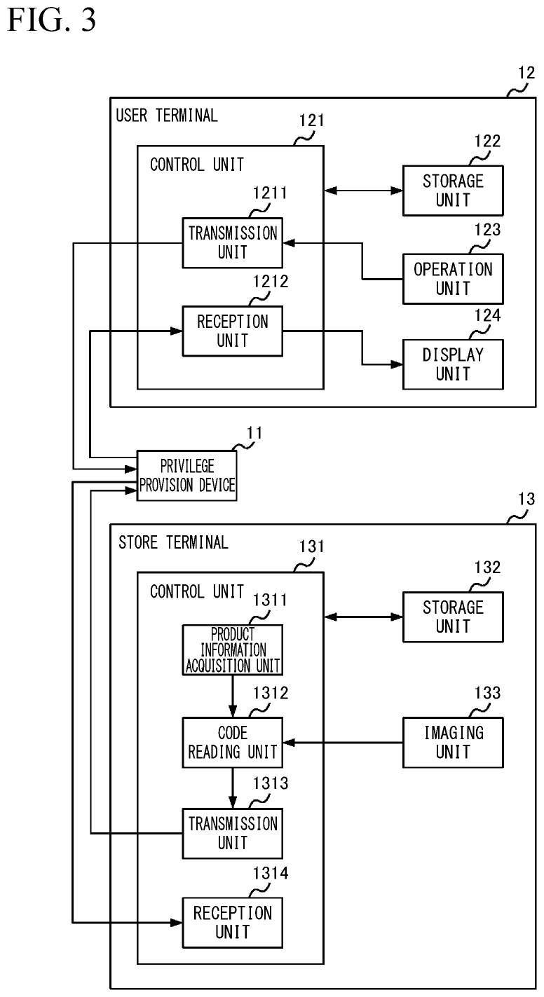

FIG. 2 is a block diagram of the privilege provision device 11 according to the first embodiment. FIG. 3 is a block diagram of the user terminal 12 and the store terminal 13 according to the first embodiment. In FIGS. 2 and 3, arrows indicate a primary flow of data, and there may be a flow of data other than the flow of data shown in FIGS. 2 and 3. In FIGS. 2 and 3, each block indicates a configuration in a unit of a function, not a configuration in a unit of hardware (device). For this reason, the blocks shown in FIGS. 2 and 3 may be implemented in a single device or may be implemented separately in a plurality of devices. Transfer of data between the blocks may be performed through any means, such as a data bus, a network, or a portable storage medium.

The privilege provision device 11 has a control unit 111 and a storage unit 112. The control unit 111 has a payment token request reception unit 1111, a validity determination unit 1112, a token generation unit 1113, a token transmission unit 1114, a payment request reception unit 1115, a privilege provision unit 1116, and a payment execution unit 1117. The storage unit 112 has a coupon storage unit 1121 and a token storage unit 1122.

The storage unit 112 is a storage medium including a read only memory (ROM), a random access memory (RAM), a hard disk drive, and the like. The storage unit 112 stores programs that are executed by the control unit 111, in advance. The storage unit 112 may be provided outside the privilege provision device 11, and in this case, the storage unit 112 may perform transfer of data with the control unit 111 through a network. The coupon storage unit 1121 stores coupon information regarding the coupon given to the user. The token storage unit 1122 stores token information indicating the token associated with the coupon. The coupon storage unit 1121 and the token storage unit 1122 may be storage areas on the storage unit 112 or may be databases constructed on the storage unit 112.

The control unit 111 is, for example, a processor, such as a central processing unit (CPU), and functions as the payment token request reception unit 1111, the validity determination unit 1112, the token generation unit 1113, the token transmission unit 1114, the payment request reception unit 1115, the privilege provision unit 1116, and the payment execution unit 1117 by executing the programs stored in the storage unit 112. At least part of the functions of the control unit 111 may be executed by an electric circuit. Alternatively, at least part of the functions of the control unit 111 may be executed by programs that are executed by way of a network.

The user terminal 12 has a control unit 121, a storage unit 122, an operation unit 123, and a display unit 124. The control unit 121 has a transmission unit 1211 and a reception unit 1212. The operation unit 123 includes an operation device that can input information by a user's operation, such as a keyboard and a mouse. The display unit 124 includes a display device that can display information, such as a liquid crystal display. The operation unit 123 and the display unit 124 may be configured integrally using a touch screen that can detect a position of a touch by the user may be used as the display unit 124.

The storage unit 122 is a storage medium including a ROM, a RAM, a hard disk drive, and the like. The storage unit 122 stores programs that are executed by the control unit 121, in advance. The storage unit 122 may be provided outside the user terminal 12, and in this case, the storage unit 122 may perform transfer of data with the control unit 121 through a network.

The control unit 121 is, for example, a processor, such as a CPU, and functions as the transmission unit 1211 and the reception unit 1212 by executing the programs stored in the storage unit 122. At least part of the functions of the control unit 121 may be executed by electric circuits. Alternatively, at least art of the functions of the control unit 121 may be executed by programs that are executed by way of a network.

The store terminal 13 has a control unit 131, a storage unit 132, and an imaging unit 133. The control unit 131 has a product information acquisition unit 1311, a code reading unit 1312, a transmission unit 1313, and a reception unit 1314. The imaging unit 133 includes an imaging device (camera, scanner, or the like) that captures an image of a predetermined imaging range. The imaging unit 133 inputs a signal indicating the captured image to the control unit 131.

The storage unit 132 is a storage medium including a ROM, a RAM, a hard disk drive, and the like. The storage unit 132 stores programs that are executed by the control unit 131, in advance. The storage unit 132 may be provided outside the store terminal 13, and in this case, the storage unit 132 may perform transfer of data with the control unit 131 through a network.

The control unit 131 is, for example, a processor, such as a CPU, and functions as the product information acquisition unit 1311, the code reading unit 1312, the transmission unit 1313, and the reception unit 1314 by executing the programs stored in the storage unit 132. At least part of the functions of the control unit 131 may be executed by an electric circuit. Alternatively, at least part of the functions of the control unit 131 may be executed by programs that are executed by way of a network.

The payment system 1S according to the first embodiment is not limited to the specific configuration shown in FIGS. 2 and 3. Each of the privilege provision device 11, the user terminal 12, the store terminal 13, and the payment server 14 may have a configuration in which two or more devices physically separated are connected in a wired or wireless manner.

### [Description of Payment Method]

Hereinafter, a payment method that is executed by the payment system 1S according to the first embodiment will be described in detail. The coupon storage unit 1121 of the privilege provision device 11 stores the coupon information regarding the coupon given to the user in advance.

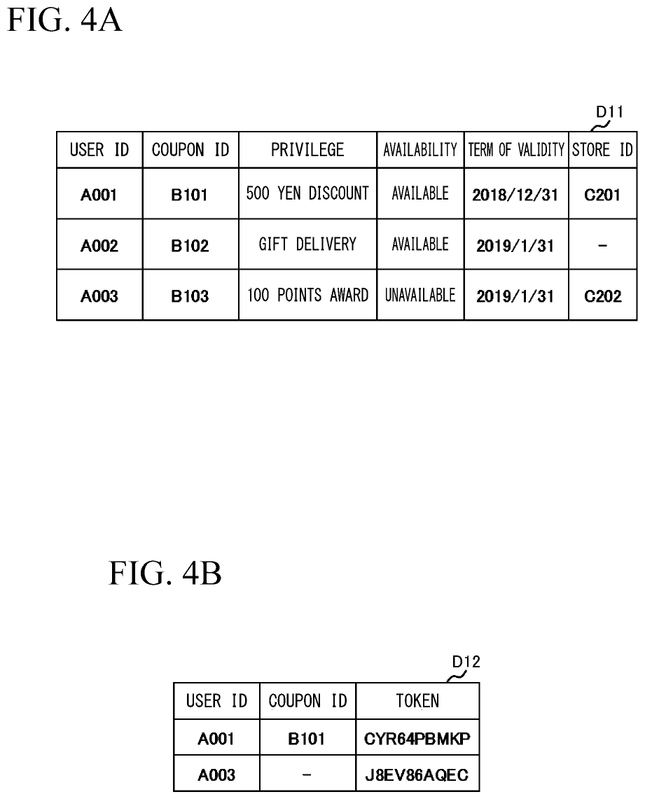

FIG. 4A is a table showing coupon information 1D1 that is stored in the coupon storage unit 1121. The coupon information 1D1 includes a user ID (user identification information) for identifying the user, a coupon ID (coupon identification information) for identifying the coupon given to the user, a privilege, availability, a term of validity, and a store ID (store identification information) for identifying the store associated with one another. The privilege indicates a privilege that is provided to the user who makes payment using the coupon. For example, the privilege is a discount of the price of a product, an offer of a gift, or an award of points. The availability indicates whether or not the coupon is available. For example, in regard to a coupon that is available only once, “available” is set in a case where the coupon is not yet used, and “unavailable” is set in a case where the coupon is used.

The term of validity indicates a term during which the coupon is available. In an example of FIG. 4A, although the term of validity indicates only an end time, the term of validity may indicate a start time in addition to the end time. The store ID indicates a store where the coupon is available. The store ID is identification information unique to the store or identification information allocated to a group (member store) of a plurality of stores. The coupon information 1D1 may include a plurality of store IDs. In regard to a coupon that is available regardless of a store, the store ID is omitted.

In FIG. 4A, although the coupon information 1D1 is represented by a table of text strings for visibility, each piece of data may be recorded in any format and may be, for example, any of text string data, numerical data, and binary data. The coupon information 1D1 may be recorded as a database or may be recorded as a list in which data is listed.

The user starts application software for making payment on the user terminal 12 before purchasing a product in the store. At this point of time, since the user does not yet select a coupon, the user terminal 12 transmits a payment token request including the user ID and not including the coupon ID to the privilege provision device 11. The privilege provision device 11 generates a payment token not associated with the coupon ID by the token generation unit 1113 described below and transmits the payment token to the user terminal 12. The user terminal 12 generates a payment code that is a text string or an image generated by encoding the received payment token with a predetermined method. Then, the user terminal 12 displays a payment screen that presents the payment code for making payment, on the display unit 124.

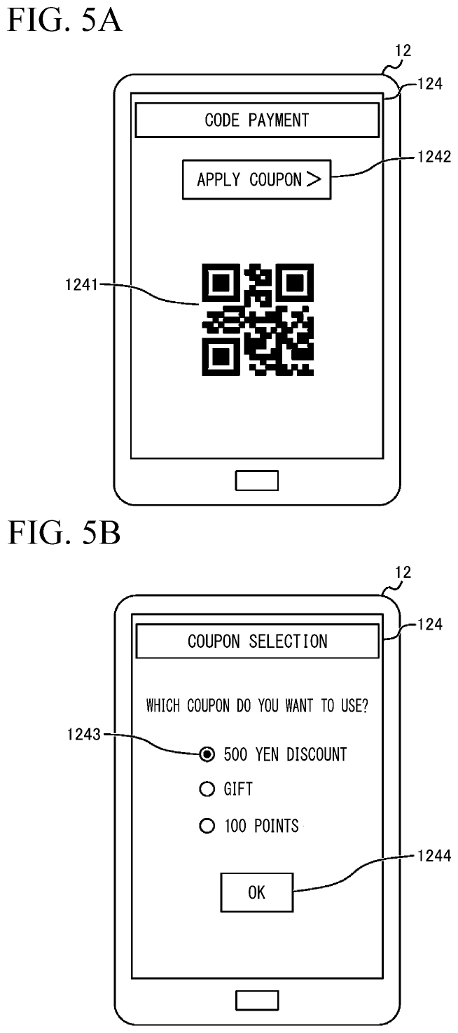

FIG. 5A is a front view of the user terminal 12 that displays a payment screen. The payment screen includes a payment code 1241 and a button 1242 for transition to a coupon selection screen. The button 1242 is a virtual button (icon) that can be pressed down by the user. The payment code 1241 is a payment code indicating the payment token received from the privilege provision device 11. A coupon is not applied to the payment code 1241 at this point of time. In a case of making payment without using a coupon, the user presents the payment code 1241 to the store terminal 13. In a case of making payment using a coupon, the user presses down the button 1242 using the operation unit 123 of the user terminal 12. In a case where the button 1242 is pressed down on the payment screen, the user terminal 12 displays a coupon selection screen for selecting a coupon on the display unit 124.

FIG. 5B is a front view of the user terminal 12 that displays a coupon selection screen. The coupon selection screen includes coupons 1243 given to the user and a button 1244 for deciding selection. In an example of FIG. 5B, although the user terminal 12 displays the contents of privileges as the coupons 1243, the user terminal 12 may display the terms of validity of the coupons in addition to the contents of the privileges. The user terminal 12 may read information regarding the coupons 1243 stored in advance in the storage unit 122 of the user terminal 12 at the time of the display of the coupon selection screen or may receive information regarding the coupons 1243 from the privilege provision device 11 at the time of the display of the coupon selection screen. The coupons 1243 can be switched between selection and non-selection corresponding to a user's operation. Any one or a plurality of coupons may be selected among a plurality of coupons 1243.

The button 1244 is a virtual button (icon) that can be pressed down by the user. The user selects the coupon 1243 that the user wants to use, using the operation unit 123 of the user terminal 12, and then, presses down the button 1244. The transmission unit 1211 of the user terminal 12 transmits a payment token request (token request) including the user ID associated with the user terminal 12 and the coupon ID associated with the coupon selected by the user to the privilege provision device 11.

The coupon selection screen may include only valid coupons 1243. In this case, the user terminal 12 transmits an inquiry about whether or not the coupons 1243 are valid, to the privilege provision device 11 at the time of the display of the coupon selection screen. In the privilege provision device 11, the validity determination unit 1112 described below determines whether or not the coupons 1243 are valid and transmits a determination result to the user terminal 12. The user terminal 12 displays the coupon selection screen including the coupons 1243 determined to be valid.

In the first embodiment, although the user terminal 12 displays the payment screen including the payment code 1241 to which a coupon is not applied, and then, displays the coupon selection screen, the user terminal 12 may display the coupon selection screen to receive selection of a coupon, and then, may display the payment screen.

In the privilege provision device 11, the payment token request reception unit 1111 (first reception unit) receives the payment token request from the user terminal 12. The validity determination unit 1112 specifies the user ID and the coupon ID included in the payment token request received by the payment token request reception unit 1111. In a case where the payment token request does not include a coupon ID (that is, in a case where a coupon is not selected by the user), the validity determination unit 1112 progresses to the generation of the payment token by the token generation unit 1113. In a case where the payment token request includes the coupon ID, the validity determination unit 1112 determines whether or not the coupon is valid based on the user ID and the coupon ID included in the payment token request. In a case where the payment token request includes a plurality of coupon IDs, the validity determination unit 1112 determines whether or not each of a plurality of coupon IDs is valid.

Specifically, the validity determination unit 1112 acquires the coupon information associated with the user ID and the coupon ID included in the payment token request from the coupon storage unit 1121. In a case where the coupon information associated with the user ID and the coupon ID is not stored in the coupon storage unit 1121, the validity determination unit 1112 determines that the coupon is not valid.

Furthermore, in a case where the availability included in the coupon information indicates that the coupon is not available, the validity determination unit 1112 determines that the coupon is not valid. In addition, in a case where a current time is out of the range of the term of validity included in the coupon information, the validity determination unit 1112 determines that the coupon is not valid.

The validity determination unit 1112 determines that the coupon is valid in a case where the coupon information associated with the user ID and the coupon ID is stored in the coupon storage unit 1121, the availability included in the coupon information indicates that the coupon is available, and the current time (the time at the time of the determination) is within the range of the term of validity included in the coupon information. A determination criterion for the validity of the coupon described herein is an example, and the validity determination unit 1112 may determine whether or not the coupon is valid based on other determination criteria. The validity determination unit 1112 may use only one of the availability and the term of validity for the determination.

The token generation unit 1113 generates the payment token. The payment token may be random data or may be data generated in association with a predetermined rule. In a case where the validity determination unit 1112 determines that the coupon is valid, the token generation unit 1113 stores the user ID, the coupon ID, and the payment token in the token storage unit 1122 in association with one another. On the other hand, in a case where the validity determination unit 1112 determines that the coupon is not valid or in a case where the payment token request does not include the coupon ID, the token generation unit 1113 stores the user ID and the payment token in the token storage unit 1122 in association with each other (that is, without association with the coupon ID).

FIG. 4B is a table showing token information 1D2 that is stored in the token storage unit 1122. The token information 1D2 includes the user ID, the coupon ID, and the payment token associated with one another. In a case where the validity determination unit 1112 determines that the coupon is not valid or in a case where the payment token request does not include a coupon ID (that is, in a case where a coupon is not selected by the user), the coupon ID is set blank. In this case, the payment token is not associated with the coupon ID in the token storage unit 1122.

In the FIG. 4B, although the token information 1D2 is represented by a table of text strings for visibility, each piece of data may be recorded in any format and may be, for example, any of text string data, numerical data, and binary data. The token information 1D2 may be recorded as a database or may be recorded as a list in which data is listed.

According to such token information 1D2, whether or not the payment token is associated with the coupon ID in the token storage unit 1122 represents the determination result of the validity determination unit 1112 about whether or not the coupon is valid.

In an example of FIG. 4B, although one token storage unit 1122 stores the payment tokens in both a case where the validity determination unit 1112 determines that the coupon is valid and a case where the validity determination unit 1112 determines that the coupon is not valid, the token storage unit 1122 may store only the payment token in a case where the validity determination unit 1112 determines that the coupon is valid.

In this case, whether or not the payment token is stored in the token storage unit 1122 represents the determination result of the validity determination unit 1112 about whether or not the coupon is valid.

The token transmission unit 1114 transmits the determination result of the validity determination unit 1112 about whether or not the coupon is valid and the payment token generated by the token generation unit 1113 to the user terminal 12. The reception unit 1212 of the user terminal 12 receives the determination result and the payment token from the privilege provision device 11.

The reception unit 1212 generates a payment code by encoding the received payment token with a predetermined method. The payment code may be, for example, a barcode, a two-dimensional code, a text string, or two or more thereof. The payment code may be in other forms as long as the store terminal 13 can read the payment code. Then, the reception unit 1212 displays a payment screen that presents the received determination result and the generated payment code, on the display unit 124.

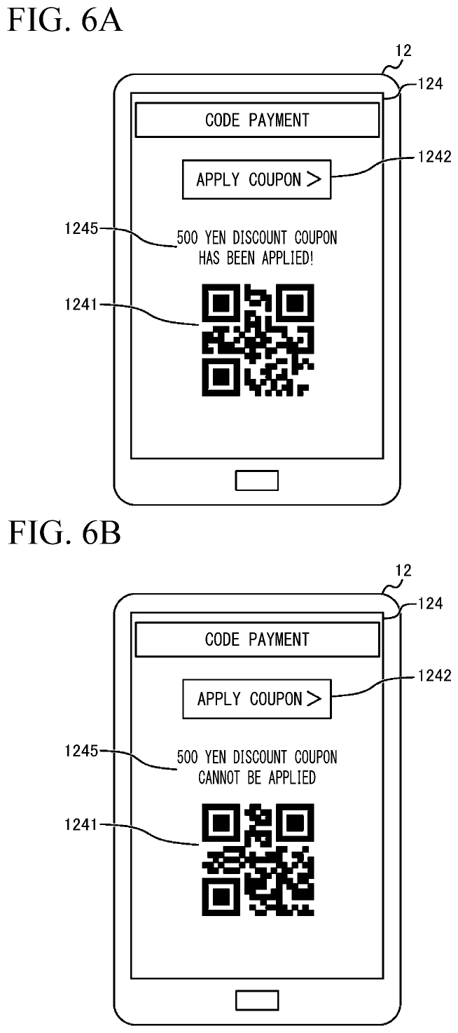

FIGS. 6A and 6B are front views of the user terminal 12 that displays a payment screen. The payment screen includes the payment code 1241, the button 1242 for transition to the coupon selection screen, and a determination result 1245. The payment code 1241 is a payment code generated based on the payment token generated by the token generation unit 1113 of the privilege provision device 11. In a case where the user presses down the button 1242, the above-described coupon selection is performed again.

The determination result 1245 is information representing the determination result of the validity determination unit 1112 of the privilege provision device 11 about whether or not the coupon is valid. Since FIG. 6A shows the payment screen in a case where determination is made that the coupon is valid, the determination result 1245 represents that the coupon is valid. On the other hand, since FIG. 6B shows the payment screen in a case where determination is made that the coupon is not valid, the determination result 1245 represents that the coupon is not valid.

The user presents a product that the user wants to purchase, to the store terminal 13, and then, presents a payment code displayed on the user terminal 12 to the store terminal 13. In the store terminal 13, the product information acquisition unit 1311 acquires product information including a price of the product that the user wants to purchase. For example, the product information acquisition unit 1311 acquires the product information by reading a barcode attached to the product suing the imaging unit 133. The product information acquisition unit 1311 may acquire the product information input by the salesclerk of the store.

After the product information acquisition unit 1311 acquires the product information, the code reading unit 1312 reads the payment code displayed on the user terminal 12 using the imaging unit 133. The code reading unit 1312 acquires the payment token indicated by the payment code by decoding the read payment code with a predetermined method. The transmission unit 1313 calculates a payment amount by totaling the price of the product that the user wants to purchase and transmits a payment request including payment information including the calculated payment amount, the payment token acquired by the code reading unit 1312, and the store ID of the store managing the store terminal 13, to the privilege provision device 11.

In the privilege provision device 11, the payment request reception unit 1115 receives the payment request from the store terminal 13. The payment request reception unit 1115 searches for the payment token included in the received payment request from the token storage unit 1122. In a case where the payment token included in the received payment request cannot be found on the token storage unit 1122, the payment request reception unit 1115 may end the processing without executing payment or may progress to execution of payment by the payment execution unit 1117 without applying the coupon.

In a case where the payment token included in the payment request is found on the token storage unit 1122, the payment request reception unit 1115 specifies the user ID and the coupon ID corresponding to the payment token included in the payment request in the token storage unit 1122. In a case where the coupon ID corresponding to the payment token included in the payment request cannot be specified (that is, in a case where the coupon ID is not associated with the payment token in the token storage unit 1122), the payment request reception unit 1115 progresses to execution of payment by the payment execution unit 1117 without applying the coupon.

In a case where the payment request reception unit 1115 specifies the coupon ID based on the payment request (that is, in a case where the coupon ID is associated with the payment token in the token storage unit 1122), the validity determination unit 1112 re-determines whether or not the coupon is valid based on the user ID and the coupon ID corresponding to the payment token included in the payment request. In a case where the payment token included in the payment request corresponds to a plurality of coupon IDs, the validity determination unit 1112 re-determines whether or not each of a plurality of coupon IDs is valid.

Specifically, the validity determination unit 1112 acquires the coupon information associated with the user ID and the coupon ID corresponding to the payment token included in the payment request from the coupon storage unit 1121. In a case where the coupon information associated with the user ID and the coupon ID is not stored in the coupon storage unit 1121, the validity determination unit 1112 determines that the coupon is not valid. Furthermore, in a case where the availability included in the coupon information indicates that the coupon is not available, the validity determination unit 1112 determines that the coupon is not valid. In addition, in a case where a current time is out of the range of the term of validity included in the coupon information, the validity determination unit 1112 determines that the coupon is not valid. In a case where the store ID included in the payment request is not included in the store ID included in the coupon information, the validity determination unit 1112 determines that the coupon is not valid.

The validity determination unit 1112 determines that the coupon is valid in a case where the coupon information associated with the user ID and the coupon ID is stored in the coupon storage unit 1121, the availability included in the coupon information indicates that the coupon is available, the current time (the time at the time of the re-determination) is within the range of the term of validity included in the coupon information, and the store ID included in the payment request is included in the store ID included in the coupon information. A determination criterion for the validity of the coupon described herein is an example, and the validity determination unit 1112 may determine whether or not the coupon is valid based on other determination criteria. The validity determination unit 1112 may use only part of the availability, the term of validity, and the store ID for the determination.

In a case where determination is made that the coupon is not valid, the validity determination unit 1112 may end the processing without executing payment or may progress to execution of payment by the payment execution unit 1117 without applying the coupon.

In this way, the privilege provision device 11 determines the validity of the coupon when the payment token request is received from the user terminal 12, and then, re-determines the validity of the coupon when the payment request is received from the store terminal 13. Then, the privilege provision device 11 provides the user with the privilege by the coupon in a case where the validity determination unit 1112 determines that the coupon is valid both when the payment token request reception unit 1111 receives the payment token request and when the payment request reception unit 1115 receives the payment request. With this, for example, even in a case where a coupon is valid when the user selects the coupon and the coupon is invalid when the user purchases a product (in a case where the term of validity has expired, or the like), the privilege provision device 11 can correctly determine an available condition of the coupon to make payment without applying the coupon.

The re-determination of the validity determination unit 1112 when the payment request is received may be omitted. In this case, the validity determination unit 1112 determines whether or not the coupon given to the user associated with the user ID included in the payment token request is valid when the payment token request reception unit 1111 receives the payment token request and does not determine whether or not the coupon associated with the coupon ID corresponding to the payment token included in the payment request is valid when the payment request reception unit 1115 receives the payment request.

On the other hand, the determination of the validity determination unit 1112 when the payment token request is received may be omitted, and only the determination of the validity determination unit 1112 when the payment request is received may be performed. In this case, the validity determination unit 1112 does not determine whether or not the coupon given to the user associated with the user ID included in the payment token request is valid when the payment token request reception unit 1111 receives the payment token request, and stores the user ID, the coupon ID, and the payment token in the token storage unit 1122 in association with one another. Then, the validity determination unit 1112 determines whether or not the coupon associated with the coupon ID corresponding to the payment token included in the payment request is valid when the payment request reception unit 1115 receives the payment request.

In a case where the validity determination unit 1112 determines that the coupon is valid, the privilege provision unit 1116 specifies the privilege included in the coupon information acquired from the coupon storage unit 1121 and associated with the user ID and the coupon ID corresponding to the payment token included in the payment request. Then, the privilege provision unit 1116 provides the user of the user ID corresponding to the payment token with the specified privilege. In a case where the privilege by the coupon is an offer of a gift or an award of points, the privilege provision unit 1116 outputs information for offering the gift or awarding the points to the user. In a case where the privilege by the coupon is a discount of a price of a product, the privilege provision unit 1116 subtracts a discount amount by the coupon from the payment amount (the price of the product as a payment target) of the payment information included in the payment request.

The payment execution unit 1117 executes payment by transmitting the payment amount of the payment information included in the payment request (or the payment amount to which the discount by the coupon is applied) to the payment server 14. The payment server 14 executes payment processing in a case where the payment amount received from the privilege provision device 11 is within a balance (for example, a credit balance or a pre-paid balance) payable by the user and does not execute the payment processing otherwise.

The payment server 14 transmits a payment result indicating whether or not payment is made, to the privilege provision device 11. The payment execution unit 1117 of the privilege provision device 11 receives the payment result from the payment server 14 and notifies the store terminal 13 of the payment result. The reception unit 1314 of the store terminal 13 receives the payment result from the privilege provision device 11 and stores the payment result in the storage unit 132.

The payment execution unit 1117 may calculate a charge for the store that manages the store terminal 13. The charge is a charge that is paid to a payment service provider managing the privilege provision device 11 by the store managing the store terminal 13 to make payment using the privilege provision device 11. The charge is calculated, for example, by multiplying the payment amount by a predetermined coefficient. In this case, in a case where the privilege provision unit 1116 subtracts the discount amount by the coupon from the payment amount (the price of the product as a payment target), the payment execution unit 1117 calculates the charge based on the payment amount after subtraction. On the other hand, in a case where the privilege provision unit 1116 does not subtract the discount amount by the coupon from the payment amount, the payment execution unit 1117 calculates the charge based on the original payment amount. The payment execution unit 1117 outputs information indicating the calculated charge by storing information in the storage unit 112 or transmitting information to the store terminal 13. With this, the privilege provision device 11 can automatically reflect the discount amount by the coupon to correctly calculate the charge that is paid to the payment service provider by the store.

### [Sequence of Payment Method]

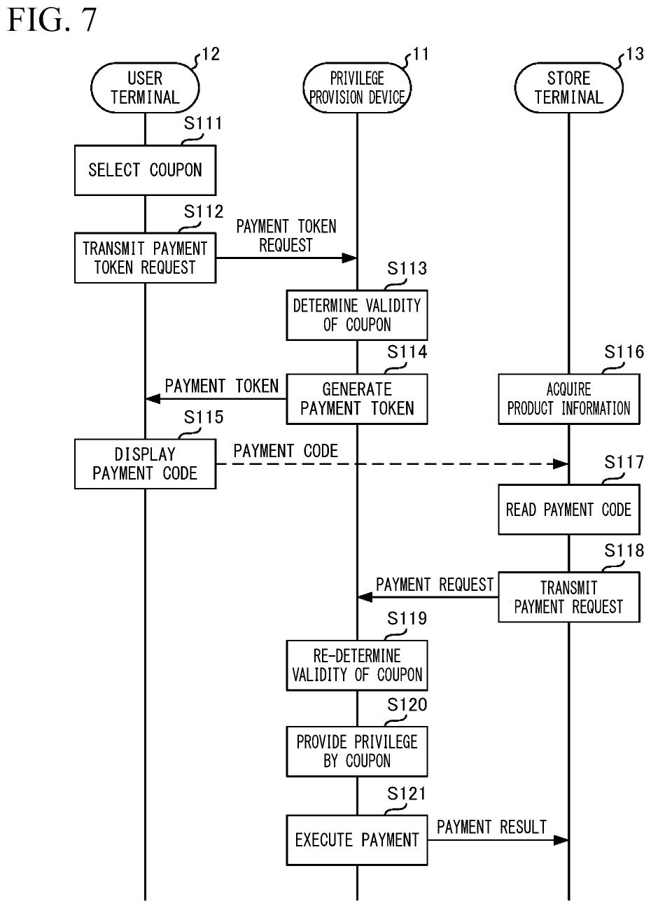

FIG. 7 is a sequence diagram of a payment method (information processing method) that is executed by the payment system 1S according to the first embodiment. The user terminal 12 receives user's selection of a coupon using the operation unit 123 (S111). The transmission unit 1211 of the user terminal 12 transmits a payment token request including the user ID associated with the user terminal 12 and the coupon ID associated with the coupon selected by the user, to the privilege provision device 11

(S112).

In the privilege provision device 11, the payment token request reception unit 1111 receives the payment token request from the user terminal 12. The validity determination unit 1112 specifies the user ID and the coupon ID included in the payment token request received by the payment token request reception unit 1111. In a case where the payment token request does not include the coupon ID (that is, in a case where a coupon is not selected by the user), the validity determination unit 1112 progresses to generation of a payment token by the token generation unit 1113 in Step S114.

In a case where the payment token request includes the coupon ID, the validity determination unit 1112 determines whether or not the coupon is valid based on the user ID and the coupon ID included in the payment token request (S113). The token generation unit 1113 generates a payment token (S114). In a case where the validity determination unit 1112 determines that the coupon is valid, the token generation unit 1113 stores the user ID, the coupon ID, and the payment token in the token storage unit 1122 in association with one another. On the other hand, in a case where the validity determination unit 1112 determines that the coupon is not valid or in a case where the payment token request does not include the coupon ID, the token generation unit 1113 stores the user ID and the payment token in the token storage unit 1122 in association with each other.

The token transmission unit 1114 transmits the determination result of the validity determination unit 1112 about whether or not the coupon is valid and the payment token generated by the token generation unit 1113 to the user terminal 12. The reception unit 1212 of the user terminal 12 receives the determination result and the payment token from the privilege provision device 11. The reception unit 1212 generates a payment code by encoding the received payment token with a predetermined method. Then, the reception unit 1212 displays the payment screen that presents the received determination result and the generated payment code, on the display unit 124

(S115).

In the store terminal 13, the product information acquisition unit 1311 acquires product information including a price of a product that the user wants to purchase (S116). After the product information acquisition unit 1311 acquires the product information, the code reading unit 1312 reads the payment code displayed on the user terminal 12 using the imaging unit 133 (S117). In FIG. 7, a state in which the payment code is transferred optically, not through communication, is represented by a broken line.

The code reading unit 1312 acquires the payment token indicated by the payment code by decoding the read payment code with a predetermined method. The transmission unit 1313 calculates a payment amount by totaling the price of the product that the user wants to purchase and transmits a payment request including payment information including the calculated payment amount, the payment token acquired by the code reading unit 1312, and the store ID of the store managing the store terminal 13, to the privilege provision device 11 (S118).

In the privilege provision device 11, the payment request reception unit 1115 receives the payment request from the store terminal 13. The payment request reception unit 1115 searches for the payment token included in the received payment request from the token storage unit 1122. The payment request reception unit 1115 specifies the user ID and the coupon ID corresponding to the payment token included in the payment request in the token storage unit 1122. In a case where the coupon ID corresponding to the payment token included in the payment request cannot be specified (that is, in a case where the coupon ID is not associated with the payment token in the token storage unit 1122), the payment request reception unit 1115 progresses to execution of payment by the payment execution unit 1117 in Step S121 without applying the coupon.

In a case where the coupon ID corresponding to the payment token included in the payment request is specified (that is, in a case where the coupon ID is associated with the payment token in the token storage unit 1122), the validity determination unit 1112 re-determines whether or not the coupon is valid based on the user ID and the coupon ID corresponding to the payment token included in the payment request (S119). The re-determination of Step S119 may be omitted. Alternatively, the determination of Step S113 may be omitted, and only the determination of Step S119 may be performed. In a case where determination is made that the coupon is not valid, the validity determination unit 1112 may end the processing without executing payment or may progress to execution of payment by the payment execution unit 1117 in Step S121 without applying the coupon.

In a case where the validity determination unit 1112 determines that the coupon is valid, the privilege provision unit 1116 specifies the privilege included in the coupon information acquired from the coupon storage unit 1121 and associated with the user ID and the coupon ID corresponding to the payment token included in the payment request. Then, the privilege provision unit 1116 provides the user of the user ID corresponding to the payment token with the specified privilege (S120).

The payment execution unit 1117 executes payment by transmitting the payment amount of the payment information included in the payment request (or the payment amount to which the discount by the coupon is applied) to the payment server 14 (S121). The payment server 14 executes payment processing in a case where the payment amount received from the privilege provision device 11 is within a balance (for example, a credit balance or a pre-paid balance) payable by the user, and does not execute the payment processing otherwise. The payment server 14 transmits a payment result indicating whether or not payment is made, to the privilege provision device 11. The payment execution unit 1117 of the privilege provision device 11 receives the payment result from the payment server 14 and notifies the store terminal 13 of the payment result. The reception unit 1314 of the store terminal 13 receives the payment result from the privilege provision device 11 and stores the payment result in the storage unit 132.

### Effects of First Embodiment

With the payment system 1S according to the first embodiment, the privilege provision device 11 transmits the payment token associated with the coupon ID to the user terminal 12 after determining the validity of the coupon when the payment token request is received from the user terminal 12, and provides the user with the privilege of the coupon corresponding to the payment token when the payment request including the payment token is received from the store terminal 13. For this reason, the payment system 1S can reduce a processing burden on the store terminal 13, and does not need costs to improve the processing performance of the store terminal 13. Furthermore, since a manager of the store does not need to register information of the coupon in the store terminal 13, it is possible to reduce a management burden on the manager of the store.

### First Modification Example

The privilege provision device 11 may determine whether or not a coupon is valid based on a product that the user purchases. In this case, the coupon information 1D1 shown in FIG. 4A further includes a product ID (product identification information) for identifying a product as an application target of a coupon. The product ID is identification information unique to each product or identification information allocated to a type (item) of a product. The coupon information 1D1 may include a plurality of product IDs. In regard to a coupon that is available regardless of a product, the product ID is omitted.

In the store terminal 13, after the product information acquisition unit 1311 acquires product information, and the code reading unit 1312 acquires a payment token, the transmission unit 1313 transmits a payment request including payment information including the payment amount, the payment token acquired by the code reading unit 1312, the store ID of the store managing the store terminal 13, and the product ID of the product as a payment target, to the privilege provision device 11. In the privilege provision device 11, in a case where the payment request is received from the store terminal 13, the payment request reception unit 1115 specifies the user ID and the coupon ID corresponding to the payment token included in the payment request in the token storage unit 1122.

The validity determination unit 1112 determines whether or not the coupon is valid based on the user ID and the coupon ID corresponding to the payment token included in the payment request. Here, the validity determination unit 1112 performs determination using the product ID in addition to the determination using the availability, the term of validity, and the store ID described above. Specifically, the validity determination unit 1112 determines that the coupon is not valid in a case where the product ID included in the payment request is not included in the product ID included in the coupon information.

The validity determination unit 1112 determines that the coupon is valid in a case where the coupon information associated with the user ID and the coupon ID is stored in the coupon storage unit 1121, the availability included in the coupon information indicates that the coupon is available, the current time is within the range of the term of validity included in the coupon information, the store ID included in the payment request is included in the store ID included in the coupon information, and the product ID included in the payment request is included in the product ID included in the coupon information. The validity determination unit 1112 may use only part of the availability, the term of validity, the store ID, and the product ID for the determination. With such a configuration, the privilege provision device 11 can determine the applicability of the coupon based on the product as a payment target.

### Second Modification Example

A term of validity may be set in the payment token. In this case, in the privilege provision device 11, when the payment token is generated, the token generation unit 1113 stores a generation time when the payment token is generated, in the storage unit 112.

The payment request reception unit 1115 receives the payment request from the store terminal 13, and the validity determination unit 1112 re-determines whether or not the coupon is valid based on the user ID and the coupon ID corresponding to the payment token included in the payment request. In a case where the validity determination unit 1112 determines that the coupon is valid, the privilege provision unit 1116 specifies the privilege by the coupon based on the coupon information acquired from the coupon storage unit 1121 and associated with the user ID and the coupon ID corresponding to the payment token included in the payment request. The privilege provision unit 1116 acquires the generation time of the payment token included in the payment request from the storage unit 112.

Then, the privilege provision unit 1116 provides the user associated with the user ID corresponding to the payment token with the specified privilege if a time when the payment request reception unit 1115 receives the payment request is within a predetermined time (for example, five minutes) from the generation time of the payment token. On the other hand, the privilege provision unit 1116 does not provide the privilege in a case where the time when the payment request reception unit 1115 receives the payment request is after the predetermined time from the generation time of the payment token. With this, the payment system 1S can prevent the payment token from being misappropriated and can improve security.

The privilege provision device 11 may receive a reacquisition request for reacquiring a payment token from the user terminal 12. In the user terminal 12, in a case where a predetermined time has elapsed after the reception unit 1212 receives the payment token or in a case where the user performs an operation for reacquisition using the operation unit 123, the transmission unit 1211 transmits the reacquisition request including the payment token received by the reception unit 1212 to the privilege provision device 11.

In the privilege provision device 11, in a case where the payment token request reception unit 1111 acquires the reacquisition request from the user terminal 12, the token generation unit 1113 generates a new payment token in association with the payment token included in the reacquisition request. The token generation unit 1113 stores a generation time when the new payment token is generated, in the storage unit 112. Then, the token transmission unit 1114 transmits the new payment token to the user terminal 12.

In this case, the validity determination unit 1112 may determine whether or not the coupon is valid based on the user ID and the coupon ID corresponding to the payment token included in the reacquisition request. In a case where the validity determination unit 1112 determines that the coupon is not valid, information indicating that the coupon is not valid may be transmitted to the user terminal 12.

The user terminal 12 regenerates a payment code by encoding the new payment token transmitted from the privilege provision device 11 with a predetermined method and displays the payment code on the display unit 124. In this way, since the original payment token and the new payment token are associated with each other when the reacquisition request is received from the user terminal 12, the privilege provision device 11 can extend the term of validity while maintaining the coupon information associated with the original payment token in the token storage unit 1122 (that is, without reacquiring the user ID and the coupon ID and storing the user ID and the coupon ID in the token storage unit 1122).

### Third Modification Example

In the above description, although the privilege provision device 11 uses the coupon selected by the user in the user terminal 12 for payment, the privilege provision device 11 may specify a coupon given to the user and may use the coupon for payment.

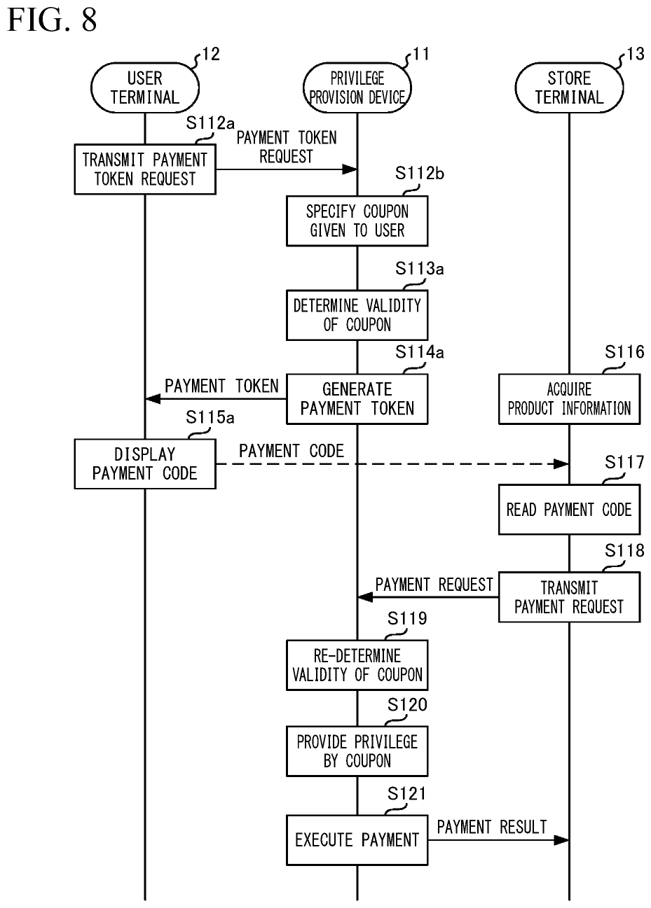

FIG. 8 is a sequence diagram of a payment method (information processing method) according to a third modification example. In the following description, different points from the sequence diagram of FIG. 7 will be primarily described. First, the transmission unit 1211 of the user terminal 12 transmits a payment token request including the user ID associated with the user terminal 12 to the privilege provision device 11 (S112a). Unlike FIG. 7, the payment token request does not include the coupon ID associated with the coupon selected by the user.

In the privilege provision device 11, the payment token request reception unit 1111 receives the payment token request from the user terminal 12. The validity determination unit 1112 specifies the coupon ID (that is, the coupon given to the user) associated with the user ID included in the payment token request received by the payment token request reception unit 1111, in the coupon storage unit 1121 (S112b). In a case where there is no coupon ID associated with the user ID in the coupon storage unit 1121, the validity determination unit 1112 progresses to generation of a payment token by the token generation unit 1113 in Step S114a. In a case where there is the coupon ID associated with the user ID in coupon storage unit 1121, the validity determination unit 1112 determines whether or not the coupon is valid based on the user ID and the coupon

ID (S113a).

The token generation unit 1113 generates a payment token (S114a). In a case where the validity determination unit 1112 determines that the coupon is valid, the token generation unit 1113 stores the user ID, the coupon ID, and the payment token in the token storage unit 1122 in association with one another. On the other hand, in a case where the validity determination unit 1112 determines that the coupon is not valid or in a case where there is not coupon ID associated with the user ID in the coupon storage unit 1121, the token generation unit 1113 stores the user ID and the payment token in the token storage unit 1122 in association with each other.

The token transmission unit 1114 transmits the payment token generated by the token generation unit 1113 to the user terminal 12. In a case where there is the coupon ID associated with the user ID in the coupon storage unit 1121, and in a case where the validity determination unit 1112 determines that the coupon of the coupon ID is valid, the token transmission unit 1114 transmits the coupon information of the coupon to the user terminal 12 in addition to the payment token. The reception unit 1212 of the user terminal 12 receives the payment token and the coupon information from the privilege provision device 11.

The reception unit 1212 generates a payment code by encoding the received payment token with a predetermined method. Then, the reception unit 1212 displays a payment screen that presents the generated payment code, on the display unit 124 (S115a). In a case where the reception unit 1212 receives the coupon information along with the payment token, the user terminal 12 displays the received coupon information on the display unit 124. The processing after Step S116 is the same as in FIG. 7. The re-determination of Step S119 may be omitted. Alternatively, the determination of Step S113a may be omitted, and only the determination of Step S119 may be performed. In this way, in the payment method according to the third modification example, the privilege provision device 11 can specify the coupon given to the user and automatically apply the coupon to payment without receiving user's selection of the coupon.

In Step S115a, the user terminal 12 may receive selection about whether or not to apply the coupon corresponding to the coupon information received by the reception unit 1212, from the user on the coupon selection screen shown in FIG. 5B. In this case, in Step S120, the privilege provision unit 1116 of the privilege provision device 11 provides the user with only the privilege of the coupon that the user selects to apply. With this, the privilege provision device 11 can specify the coupon given to the user, and then, can apply the coupon to payment after receiving selection about whether or not to apply the coupon, from the user.

Although the present invention has been described in connection with the embodiment, the technical scope of the present invention is not limited to the range described in the above-described embodiment, and various modifications and alterations can be made within the scope of the spirit of the present invention. For example, specific embodiments of dispersion or integration of the device are not limited to the above-described embodiment, all or part thereof, can be configured with any unit that is functionally or physically dispersed or integrated. New embodiments generated by any combinations of a plurality of embodiments are also included in the embodiments of the present invention. The effects of the new embodiments generated by the combinations also have the effects of the original embodiment.

The processors of the privilege provision device 11, the user terminal 12, the store terminal 13, and the payment server 14 are the core of each step (process) included in the payment method shown in FIGS. 7 and 8. That is, the processors of the privilege provision device 11, the user terminal 12, the store terminal 13, and the payment server 14 execute the payment method shown in FIGS. 7 and 8 by reading the programs for executing the payment method shown in FIGS. 7 and 8 from the storage units and executing the programs to control the units of the payment system 1S. The steps included in the payment method shown in FIGS. 7 and 8 may be partially omitted, the order of the steps may be changed, or a plurality of steps may be performed in parallel.

### Second Embodiment

### [Outline of Payment System 2S]

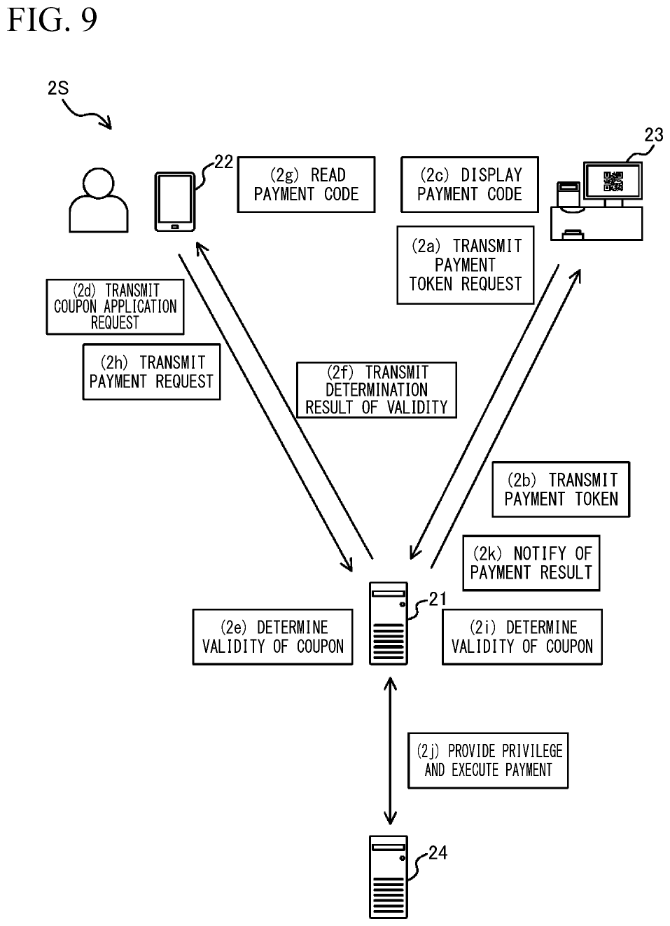

FIG. 9 is a schematic view of a payment system 2S (information processing system) according to a second embodiment. The payment system 2S includes a privilege provision device 21, a user terminal 22, a store terminal 23, and a payment server 24. The payment system 2S may include equipment, such as other servers or terminals.

The privilege provision device 21 (information processing device) is a computer that determines validity of an electronic coupon given to the user and provides the user with a privilege by the coupon. The user a customer of a stop, such as a retail store. The privilege provision device 21 can perform communication with the user terminal 22, the store terminal 23, and the payment server 24 through a network, such as the Internet or a local area network.

The user terminal 22 is a computer that receives a user's operation and displays various kinds of information. Furthermore, the user terminal 22 has a function of reading a payment code presented by the store terminal 23. The user terminal 22 is, for example, a portable terminal, such as a smartphone or a tablet terminal. The store terminal 23 is a computer that provided in a store and reads information a product purchased by the user. The store terminal 23 is, for example, a point of sale (POS) terminal or a communication terminal provided to a salesclerk of the store. The payment server 24 is a computer that makes payment of the price of the product purchased by the user. The product is an article or a service that can be purchased by the user through payment of a price.

The outline of processing in which the payment system 2S according to the second embodiment makes payment by applying a coupon will be described below. The privilege provision device 21 gives a coupon to the user in advance, and stores a user ID for identifying the user and a coupon ID for identifying the coupon in a storage unit in association with each other. The user ID may be allocated to each user or may be allocated to each user terminal 22. The user uses the coupon at the time of purchase of a product, and accordingly, the coupon provides the user with a predetermined privilege. The privilege by the coupon is, for example, a discount of a price of a product, an offer of a gift, an award of points, or the like. The user can purchase a product using the coupon given to the user at a desired timing.

The user presents a product that the user wants to purchase, to the store terminal 23 in purchasing the product in the store. The store terminal 23 acquires product information including the price of the product purchased by the user and then, transmits a payment token request including payment information, such as a payment amount of the product purchased by the user, and a store ID for identifying the store to the privilege provision device 21 (2a).

In a case where the payment token request is received, the privilege provision device 21 generates a payment token and stores the payment token in the storage unit in association with the store ID and the payment information included in the payment token request. The privilege provision device 21 transmits the generated payment token to the store terminal 23 as a transmission source of the payment token request (2b). The store terminal 23 generates a payment code based on the received payment token and displays the payment code on a display unit (2c). The payment code is a text string or an image that is readable by the user terminal 22.

The user performs an operation to select a coupon that the user wants to use, in the user terminal 22 before making the user terminal 22 read the payment code displayed on the store terminal 23. The user terminal 22 transmits a coupon application request including the user ID associated with the user terminal 22 and the coupon ID associated with the selected coupon to the privilege provision device 21 (2d).

The privilege provision device 21 determines whether or not the coupon is valid based on the user ID and the coupon ID included in the received coupon application request (2e). In this case, the privilege provision device 21 determines the validity of the coupon, for example, based on the presence or absence of the coupon, the availability of the coupon, and the term of validity of the coupon. In a case where the coupon is valid, the privilege provision device 21 stores the user ID and the coupon ID in the storage unit in association with each other. The privilege provision device 21 transmits a determination result of the validity of the coupon to the user terminal 22 as a transmission source of the coupon application request (2f). The user terminal 22 displays the received determination result on a display unit.

The user makes the user terminal 22 read the payment code displayed on the store terminal 23. The user terminal 22 reads the payment code displayed on the store terminal 23 using an imaging unit (2g). The user terminal 22 acquires the payment token indicated by the payment code by decoding the read payment code. The user terminal 22 transmits a payment request including the user ID and the payment token indicated by the read payment code to the privilege provision device 21 (2h).

The privilege provision device 21 searches for the payment token included in the received payment request from the storage unit. In a case where the payment token included in the received payment request is found on the storage unit, the privilege provision device 21 specifies the payment information corresponding to the payment token. Furthermore, the privilege provision device 21 searches for the user ID included in the received payment request from the storage unit. In a case where the user ID included in the received payment request is found on the storage unit, the privilege provision device 21 specifies the coupon ID corresponding to the user ID.

The privilege provision device 21 re-determines whether or not the coupon of the specified coupon ID is valid (2i). In this case, the privilege provision device 21 determines the validity of the coupon, for example, based on the presence or absence of the coupon, the availability of the coupon, the term of validity of the coupon, and the store ID. In a case where determination is made that the coupon of the coupon ID corresponding to the user ID included in the received payment request is valid, the privilege provision device 21 provides the user with the privilege by the coupon and transmits the payment amount of the payment information corresponding to the payment token included in the received payment request to the payment server 24 in association with the user ID (2j). Here, in a case where the privilege by the coupon is a discount, the privilege provision device 21 subtracts a discount amount by the coupon from the payment amount and transmits a result to the payment server 24.

The payment server 24 executes payment processing in a case where the payment amount received from the privilege provision device 21 is within a balance (for example, a credit balance or a pre-paid balance) payable by the user and does not execute the payment processing otherwise. The payment server 24 transmits a payment result indicating whether or not payment is made, to the privilege provision device 21. The privilege provision device 21 notifies the store terminal 23 of the payment result received from the payment server 24 (2k).

In this way, in the payment system 2S according to the second embodiment, instead of the store terminal 23, the privilege provision device 21 executes the processing of determining the validity of the coupon and the processing of applying the coupon. With this, it is possible to reduce a processing burden on the store terminal 23, and there is no need for costs to improve the processing performance of the store terminal 23. Furthermore, since a manager of the store does not need to register information of the coupon in the store terminal 23, it is possible to reduce a management burden on the manager of the store.

### [Configuration of Payment System 2S]

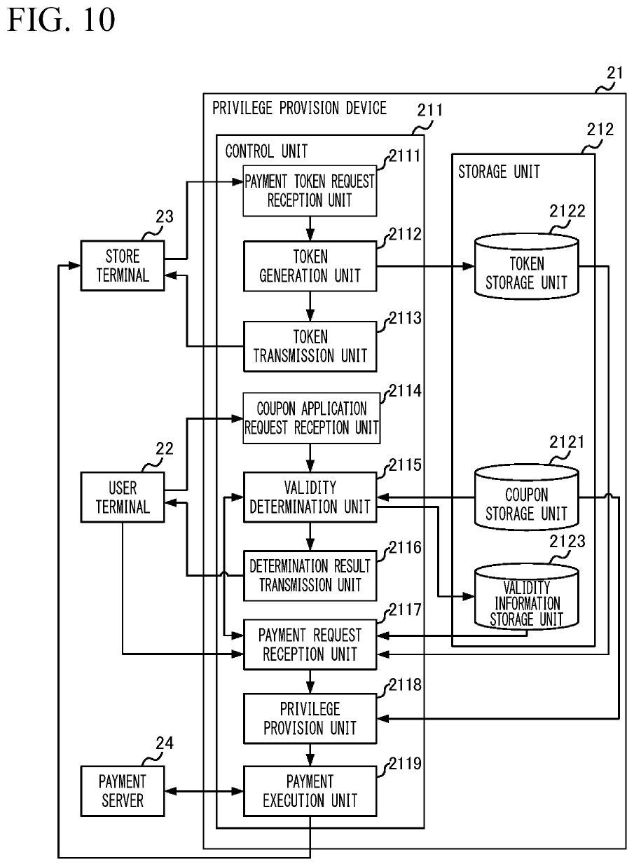

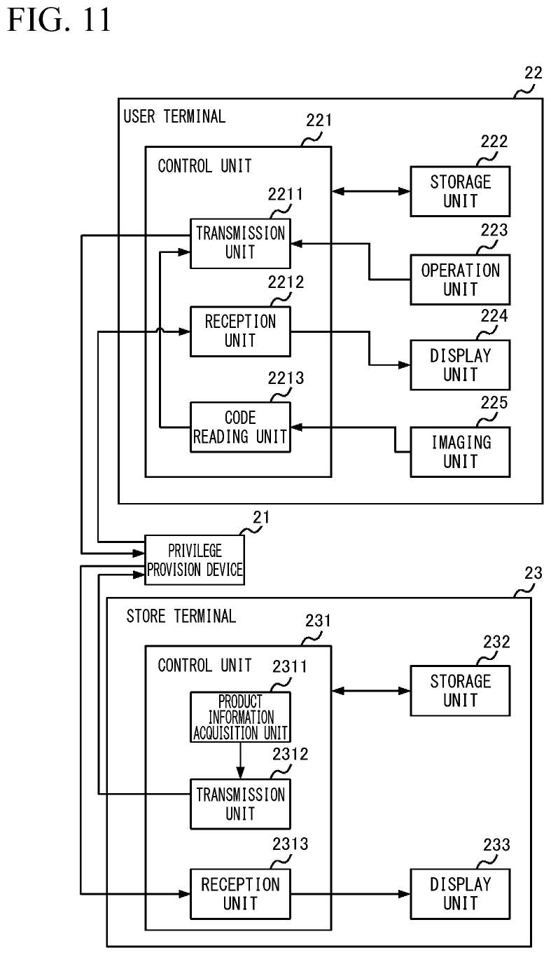

FIG. 10 is a block diagram of the privilege provision device 21 according to the second embodiment. FIG. 11 is a block diagram of the user terminal 22 and the store terminal 23 according to the second embodiment. In FIGS. 10 and 11, arrows indicate a primary flow of data, and there may be a flow of data other than the flow of data shown in FIGS. 10 and 11.

In FIGS. 10 and 11, each block indicates a configuration in a unit of a function, not a configuration in a unit of hardware (device). For this reason, the blocks shown in FIGS. 10 and 11 may be implemented in a single device or may be implemented separately in a plurality of devices. Transfer of data between the blocks may be performed through any means, such as a data bus, a network, or a portable storage medium.

The privilege provision device 21 has a control unit 211 and a storage unit 212. The control unit 211 has a payment token request reception unit 2111, a token generation unit 2112, a token transmission unit 2113, a coupon application request reception unit 2114, a validity determination unit 2115, a determination result transmission unit 2116, a payment request reception unit 2117, a privilege provision unit 2118, and a payment execution unit 2119. The storage unit 212 has a coupon storage unit 2121, a token storage unit 2122, and a validity information storage unit 2123.

The storage unit 212 is a storage medium including a read only memory (ROM), a random access memory (RAM), a hard disk drive, and the like. The storage unit 212 stores programs that are executed by the control unit 211, in advance. The storage unit 212 may be provided outside the privilege provision device 21, and in this case, the storage unit 212 may perform transfer of data with the control unit 211 through a network. The coupon storage unit 2121 stores coupon information regarding the coupon given to the user. The token storage unit 2122 stores token information indicating the token associated with the payment information. The validity information storage unit 2123 stores validity information indicating the coupon determined to be valid. The coupon storage unit 2121, the token storage unit 2122, and the validity information storage unit 2123 may be storage areas on the storage unit 212 or may be databases constructed on the storage unit 212.

The control unit 211 is, for example, a processor, such as a central processing unit (CPU), and functions as the payment token request reception unit 2111, the token generation unit 2112, the token transmission unit 2113, the coupon application request reception unit 2114, the validity determination unit 2115, the determination result transmission unit 2116, the payment request reception unit 2117, the privilege provision unit 2118, and the payment execution unit 2119 by executing the programs stored in the storage unit 212. At least part of the functions of the control unit 211 may be executed by an electric circuit. Alternatively, at least part of the functions of the control unit 211 may be executed by programs that are executed by way of a network.

The user terminal 22 has a control unit 221, a storage unit 222, an operation unit 223, a display unit 224, and an imaging unit 225. The control unit 221 has a transmission unit 2211, a reception unit 2212, and a code reading unit 2213. The operation unit 223 includes an operation device that can input information by a user's operation, such as a keyboard and a mouse. The display unit 224 includes a display device that can display information, such as a liquid crystal display. The operation unit 223 and the display unit 224 may be configured integrally using a touch screen that can detect a position of a touch by the user may be used as the display unit 224. The imaging unit 225 includes an imaging device (camera, scanner, or the like) that captures an image of a predetermined imaging range. The imaging unit 225 inputs a signal indicating the captured image to the control unit 221.

The storage unit 222 is a storage medium including a ROM, a RAM, a hard disk drive, and the like. The storage unit 222 stores programs that are executed by the control unit 221, in advance. The storage unit 222 may be provided outside the user terminal 22, and in this case, the storage unit 222 may perform transfer of data with the control unit 221 through a network.

The control unit 221 is, for example, a processor, such as a CPU, and functions as the transmission unit 2211, the reception unit 2212, and the code reading unit 2213 by executing the programs stored in the storage unit 222. At least part of the functions of the control unit 221 may be executed by an electric circuit. Alternatively, at least part of the functions of the control unit 221 may be executed by programs that are executed by way of a network.

The store terminal 23 has a control unit 231, a storage unit 232, and a display unit 233. The control unit 231 has a product information acquisition unit 2311, a transmission unit 2312, and a reception unit 2313. The display unit 233 includes a display device that can display information, such as a liquid crystal display. The storage unit 232 is a storage medium including a ROM, a RAM, a hard disk drive, and the like. The storage unit 232 stores programs that are executed by the control unit 231, in advance. The storage unit 232 may be provided outside the store terminal 23, and in this case, the storage unit 232 may perform transfer of data with the control unit 231 through a network.

The control unit 231 is, for example, a processor, such as a CPU, and functions as the product information acquisition unit 2311, the transmission unit 2312, and the reception unit 2313 by executing the programs stored in the storage unit 232. At least part of the functions of the control unit 231 may be executed by an electric circuit. Alternatively, at least part of the functions of the control unit 231 may be executed by programs that are executed by way of a network.

The payment system 2S according to the second embodiment is not limited to the specific configuration shown in FIGS. 10 and 11. Each of the privilege provision device 21, the user terminal 22, the store terminal 23, and the payment server 24 may have a configuration in which two or more devices physically separated are connected in a wired or wireless manner.

### [Description of Payment Method]

Hereinafter, a payment method that is executed by the payment system 2S according to the second embodiment will be described in detail. The coupon storage unit 2121 of the privilege provision device 21 stores coupon information regarding the coupon given to the user in advance.

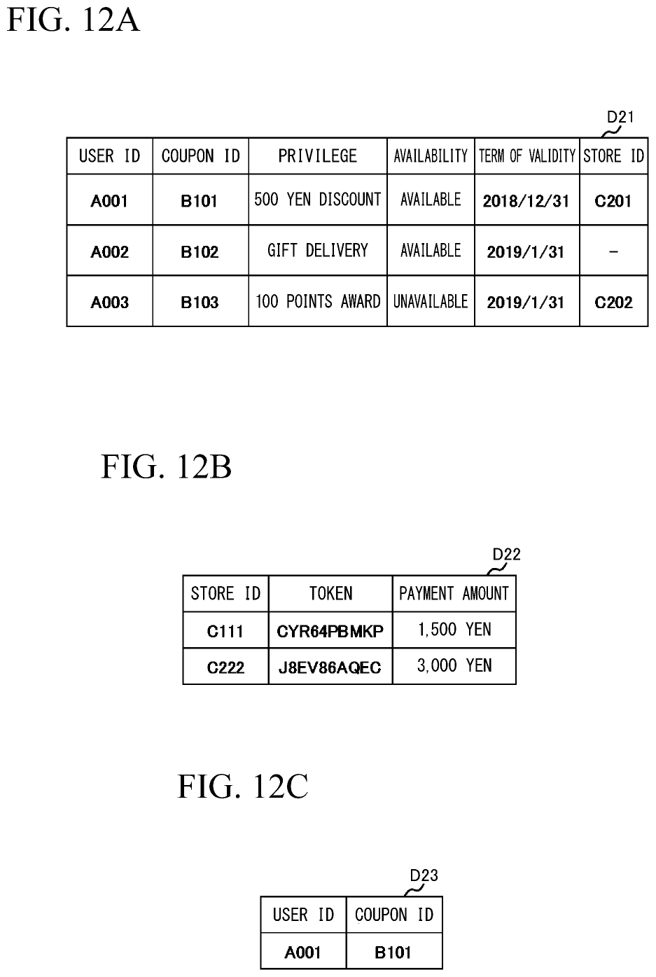

FIG. 12A is a table showing coupon information 2D1 that is stored in the coupon storage unit 2121. The coupon information 2D1 includes a user ID (user identification information) for identifying the user, a coupon ID (coupon identification information) for identifying the coupon given to the user, a privilege, availability, a term of validity, and a store ID (store identification information) for identifying the store associated with one another. The privilege indicates a privilege that is provided to the user who makes payment using the coupon. For example, the privilege is a discount of a price of a product, an offer of a gift, or an award of points. The availability indicates whether or not the coupon is available. For example, in regard to a coupon that is available only once, “available” is set in a case where the coupon is not yet used, and “unavailable” is set in a case where the coupon is used.

The term of validity indicates a term during which the coupon is available. In an example of FIG. 12A, although the term of validity indicates only an end time, the term of validity may indicate a start time in addition to the end time. The store ID indicates a store where the coupon is available. The store ID is identification information unique to the store or identification information allocated to a group (member store) of a plurality of stores. The coupon information 2D1 may include a plurality of store IDs. In regard to a coupon that is available regardless of a store, the store ID is omitted.

In FIG. 12A, although the coupon information 2D1 is represented by a table of text strings for visibility, each piece of data may be recorded in any format and may be, for example, any of text string data, numerical data, and binary data. The coupon information 2D1 may be recorded as a database or may be recorded as a list in which data is listed.

The user presents a product that the user wants to purchase, to the store terminal 23 in purchasing the product in the store. In the store terminal 23, the product information acquisition unit 2311 acquires product information including a price of the product that the user wants to purchase. For example, the product information acquisition unit 2311 acquires the product information by reading a barcode attached to the product suing an imaging unit. The product information acquisition unit 2311 may acquire the product information input by the salesclerk of the store.

The transmission unit 2312 calculates a payment amount by totaling the price of the product based on the product information acquired by the product information acquisition unit 2311 and transmits a payment token request (token request) including payment information indicating the calculated payment amount and the store ID of the store managing the store terminal 23, to the privilege provision device 21. The payment information may further include information regarding payment, such as the name of the product as a payment target, in addition to the payment amount.

In the privilege provision device 21, the payment token request reception unit 2111 receives the payment token request from the store terminal 23. The token generation unit 2112 generates a payment token if the payment token request reception unit 2111 receives the payment token request. The payment token may be random data or may be data generated in association with a predetermined rule. The token generation unit 2112 stores the store ID and the payment information included in the payment token request and the generated payment token in the token storage unit 2122 in association with each other.

FIG. 12B is a table showing token information 2D2 that is stored in the token storage unit 2122. The token information 2D2 includes the store ID, the payment token, and the payment information (here, the payment amount) associated with one another. In FIG. 12B, although the token information 2D2 is represented by a table of text strings for visibility, each piece of data may be recorded in any format and may be, for example, any of text string data, numerical data, and binary data. The token information 2D2 may be recorded as a database or may be recorded as a list in which data is listed.

The token transmission unit 2113 transmits the payment token generated by the token generation unit 2112 to the store terminal 23. The reception unit 2313 of the store terminal 23 receives the payment token from the privilege provision device 21. The reception unit 2313 generates a payment code by encoding the received payment token with a predetermined method. The payment code may be, for example, a barcode, a two-dimensional code, a text string, or two or more thereof. The payment code may be in other forms as long as the user terminal 22 can read the payment code. Then, the reception unit 2313 displays a payment screen that presents the generated payment code, on the display unit 233.

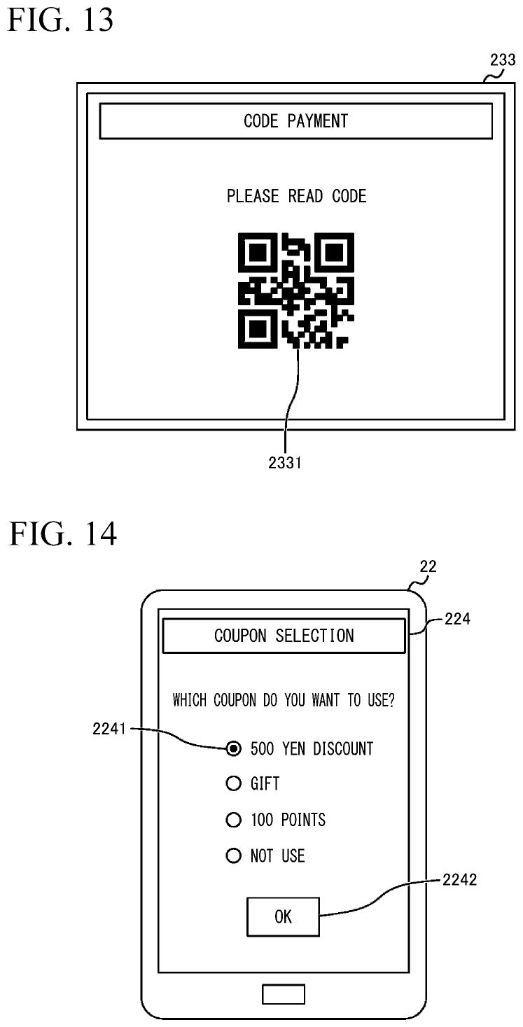

FIG. 13 is a front view of the display unit 233 of the store terminal 23 that displays a payment screen. The payment screen includes a payment code 2331. The payment code 2331 is a payment code indicating the payment token received from the privilege provision device 21.

The user starts application software for making payment on the user terminal 22 before making the user terminal 22 read the payment code displayed on the store terminal 23. Then, the user terminal 22 displays a coupon selection screen for selecting a coupon on the display unit 224.

FIG. 14 is a front view of the user terminal 22 that displays a coupon selection screen. The coupon selection screen includes coupons 2241 given to the user and a button 2242 for deciding selection. In an example of FIG. 14, although the user terminal 22 displays the contents of privileges as the coupons 2241, the user terminal 22 may display the terms of validity of the coupons in addition to the contents of the privileges. The user terminal 22 may read information regarding the coupons 2241 stored in advance in the storage unit 222 of the user terminal 22 at the time of the display of the coupon selection screen or may receive information regarding the coupons 2241 from the privilege provision device 21 at the time of the display of the coupon selection screen. The coupons 2241 can be switched between selection and non-selection corresponding to a user's operation. Any one or a plurality of coupons may be selected among a plurality of coupons 2241.

The button 2242 is a virtual button (icon) that can be pressed down by the user. The user selects the coupon 2241 that the user wants to use, using the operation unit 223 of the user terminal 22, and then, presses down the button 2242. The transmission unit 2211 of the user terminal 22 transmits a coupon application request including the user ID associated with the user terminal 22 and the coupon ID associated with the coupon selected by the user to the privilege provision device 21.

The coupon selection screen may include only valid coupons 2241. In this case, the user terminal 22 transmits an inquiry about whether or not the coupons 2241 are valid, to the privilege provision device 21 at the time of the display of the coupon selection screen. In the privilege provision device 21, the validity determination unit 2115 described below determines whether or not the coupons 2241 are valid and transmits a determination result to the user terminal 22. The user terminal 22 displays the coupon selection screen including the coupons 2241 determined to be valid.

In the privilege provision device 21, the coupon application request reception unit 2114 (first reception unit) receives the coupon application request from the user terminal 22. The validity determination unit 2115 specifies the user ID and the coupon ID included in the coupon application request received by the coupon application request reception unit 2114. The validity determination unit 2115 determines whether or not the coupon is valid based on the specified user ID and coupon ID. In a case where the coupon application request includes a plurality of coupon IDs, the validity determination unit 2115 determines whether or not each of a plurality of coupon IDs is valid.

Specifically, the validity determination unit 2115 acquires the coupon information associated with the user ID and the coupon ID included in the coupon application request from the coupon storage unit 2121. In a case where the coupon information associated with the user ID and the coupon ID are not stored in the coupon storage unit 2121, the validity determination unit 2115 determines that the coupon is not valid. Furthermore, in a case where the availability included in the coupon information indicates that the coupon is not available, the validity determination unit 2115 determines that the coupon is not valid. In addition, in a case where the current time is out of the range of the term of validity included in the coupon information, the validity determination unit 2115 determines that the coupon is not valid.

The validity determination unit 2115 determines that the coupon is valid in a case where the coupon information associated with the user ID and the coupon ID is stored in the coupon storage unit 2121, the availability included in the coupon information indicates that the coupon is available, and the current time (the time at the time of the determination) is within the range of the term of validity included in the coupon information. A determination criterion for the validity of the coupon described herein is an example, and the validity determination unit 2115 may determine whether or not the coupon is valid based on other determination criteria. The validity determination unit 2115 may determine only one of the availability and the term of validity.

In a case where determination is made that the coupon is valid, the validity determination unit 2115 stores validity information in which the user ID and the coupon ID are associated with each other, in the validity information storage unit 2123.

FIG. 12C is a table showing validity information 2D3 that is stored in the validity information storage unit 2123. The validity information 2D3 includes the user ID and the coupon ID associated with each other.

In FIG. 12C, although the validity information 2D3 is represented by a table of text strings for visibility, each piece of data may be recorded in any format and may be, for example, any of text string data, numerical data, and binary data. The validity information 2D3 may be recorded as a database or may be recorded as a list in which data is listed.

The validity information 2D3 stores a set of the user ID and the coupon ID in a case where the validity determination unit 2115 determines that the coupon is valid. For this reason, whether or not the user ID and the coupon ID are stored in the validity information storage unit 2123 represents the determination result of the validity determination unit 2115 about whether or not the coupon is valid.

The determination result transmission unit 2116 transmits the determination result of the validity determination unit 2115 about the validity of the coupon to the user terminal 22 as a transmission source of the coupon application request. The reception unit 2212 of the user terminal 22 receives the determination result from the privilege provision device 21. In a case where the reception unit 2212 receives the determination result, the user terminal 22 displays a code reading screen for reading the payment code on the display unit 224.

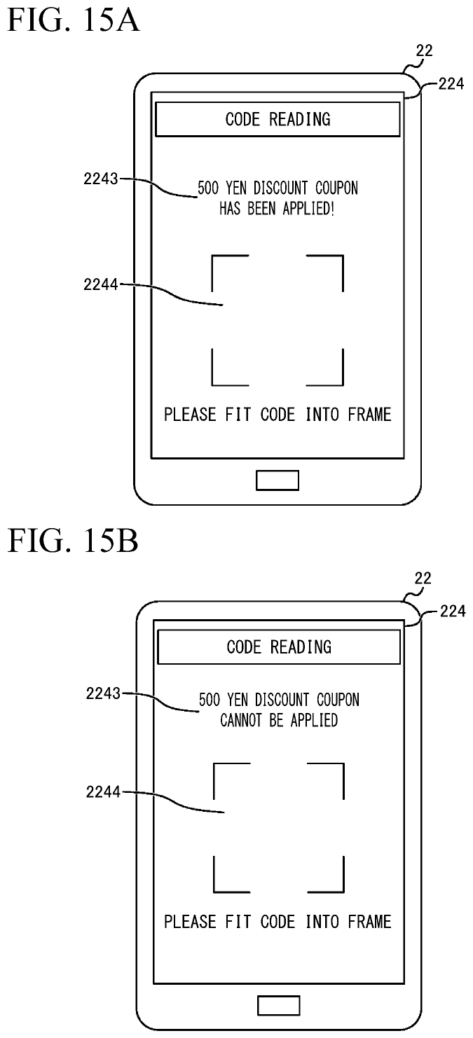

FIGS. 15A and 15B are front views of the user terminal 22 that displays a code reading screen. The code reading screen includes a determination result 2243 and a reading frame 2244. The determination result 2243 is information representing the determination result of the validity determination unit 2115 of the privilege provision device 21 about whether or not the coupon is valid. Since FIG. 15A shows the code reading screen in a case where determination is made that the coupon is valid, the determination result 2243 represents that the coupon is valid. On the other hand, since FIG. 15B shows the code reading screen in a case where determination is made that the coupon is not valid, the determination result 2243 represents that the coupon is not valid.

The reading frame 2244 is a frame that displayed on an image captured by the imaging unit 225 in a superimposed manner and represents a region where the payment code is readable. In a case of making payment, the user adjusts the payment code displayed on the store terminal 23 to enter the reading frame 2244. In the user terminal 22, the code reading unit 2213 reads the payment code displayed on the store terminal 23 using the imaging unit 225. The code reading unit 2213 acquires the payment token indicated by the payment code by decoding the read payment code with a predetermined method. The transmission unit 2211 transmits a payment request including the user ID associated with the user terminal 22 and the payment token acquired by the code reading unit 2213 to the privilege provision device 21.

In the second embodiment, although the user terminal 22 receives user's selection of the coupon before reading the payment code displayed on the store terminal 23, the user terminal 22 may receive user's selection of the coupon after reading the payment code displayed on the store terminal 23. In this case, the user terminal 22 displays the coupon selection screen of FIG. 14 to receive the selection of the coupon with reading of the payment code displayed on the store terminal 23 as a trigger and transmits the coupon application request to the privilege provision device 21. Thereafter, the user terminal 22 transmits the payment request to the privilege provision device 21 with reception of the determination result from the privilege provision device 21 as a trigger. In this way, the privilege provision device 21 can receive the user's selection of the coupon at least one of before the user terminal 22 reads the payment code and after the user terminal 22 reads the payment code.

In the privilege provision device 21, the payment request reception unit 2117 receives the payment request from the user terminal 22. The payment request reception unit 2117 searches for the payment token included in the received payment request from the token storage unit 2122. In a case where the payment token included in the payment request is found on the token storage unit 2122, the payment request reception unit 2117 specifies the store ID and the payment information corresponding to the payment token included in the payment request in the token storage unit 2122. In a case where the payment token included in the received payment request cannot be found on the token storage unit 2122, the payment request reception unit 2117 ends the processing without executing payment.

The payment request reception unit 2117 searches for the user ID included in the received payment request from the validity information storage unit 2123. In a case where the user ID included in the payment request is found on the validity information storage unit 2123 (that is, in a case where a set of the user ID and the coupon ID is stored in the validity information storage unit 2123), the payment request reception unit 2117 specifies the coupon ID corresponding to the user ID included in the payment request in the validity information storage unit 2123. In a case where the coupon ID corresponding to the user ID included in the payment request cannot be specified (that is, in a case where a set of the user ID and the coupon ID is not stored in the validity information storage unit 2123), the payment request reception unit 2117 progresses execution of payment by the payment execution unit 2119 without applying the coupon.

In a case where payment request reception unit 2117 specifies the store ID, the payment information, and the coupon ID based on the payment request, the validity determination unit 2115 re-determines whether or not the coupon is valid based on the coupon ID corresponding to the user ID included in the payment request. In a case where the user ID included in the payment request corresponds to a plurality of coupon IDs, the validity determination unit 2115 re-determines whether or not each of a plurality of coupon IDs is valid.

Specifically, the validity determination unit 2115 acquires the coupon information associated with the coupon ID associated with the user ID included in the payment request and the user ID included in the payment request from the coupon storage unit 2121. In a case where the coupon information associated with the user ID and the coupon ID are not stored in the coupon storage unit 2121, the validity determination unit 2115 determines that the coupon is not valid. Furthermore, in a case where the availability included in the coupon information indicates that the coupon is not available, the validity determination unit 2115 determines that the coupon is not valid. In addition, in a case where the current time is out of the range of the term of validity included in the coupon information, the validity determination unit 2115 determines that the coupon is not valid. In a case where the store ID corresponding to the payment token included in the payment request is not included in the store ID included in the coupon information, the validity determination unit 2115 determines that the coupon is not valid.

The validity determination unit 2115 determines that the coupon is valid in a case where the coupon information associated with the user ID and the coupon ID is stored in the coupon storage unit 2121, the availability included in the coupon information indicates that the coupon is available, the current time (the time at the time of the re-determination) is within the range of the term of validity included in the coupon information, and the store ID corresponding to the payment token included in the payment request is included in the store ID included in the coupon information.

A determination criterion for the validity of the coupon described herein is an example, and the validity determination unit 2115 may determine whether or not the coupon is valid based on other determination criteria. The validity determination unit 2115 may use only part of the availability, the term of validity, and the store ID for the determination.

In a case where determination is made that the coupon is not valid, the validity determination unit 2115 may end the processing without executing payment or may progress to execution of payment by the payment execution unit 2119 without applying the coupon.

In this way, the privilege provision device 21 determines the validity of the coupon when the coupon application request is received from the user terminal 22, and then, re-determines the validity of the coupon when the payment request is received from the user terminal 22. Then, the privilege provision device 21 provides the user with the privilege by the coupon in a case where the validity determination unit 2115 determines that the coupon is valid both when the coupon application request reception unit 2114 receives the coupon application request and when the payment request reception unit 2117 receives the payment request. With this, for example, even in a case where a coupon is valid when the user selects the coupon and the coupon is invalid when the user purchases a product (in a case where the term of validity has expired, or the like), the privilege provision device 21 can correctly determine an available condition of the coupon to make payment without applying the coupon. The re-determination of the validity determination unit 2115 when the payment request is received from the user terminal 22 may be omitted.

In the second embodiment, although the user terminal 22 transmits the payment request including the user ID and the payment token, the user terminal 22 may transmit a payment request including the coupon ID and the payment token. In this case, the payment request reception unit 2117 searches for the coupon ID included in the received payment request from the validity information storage unit 2123. In a case where the coupon ID included in the payment request is found on the validity information storage unit 2123, the payment request reception unit 2117 specifies the user ID corresponding to the coupon ID included in the payment request in the validity information storage unit 2123. Then, the validity determination unit 2115 determines the validity of the coupon using the coupon ID included in the payment request and the user ID corresponding to the coupon ID included in the payment request. In this way, the privilege provision device 21 can determine the validity of the coupon by receiving the payment request including at least one of the user ID and the coupon ID.

In a case where the validity determination unit 2115 determines that the coupon is valid, the privilege provision unit 2118 specifies the privilege included in the coupon information acquired from the coupon storage unit 2121 and associated with the user ID and the coupon ID. Then, the privilege provision unit 2118 provides the user of the user ID included in the payment request or the user ID corresponding to the coupon ID included in the payment request with the specified privilege. In a case where the privilege by the coupon is an offer of a gift or an award of points, the privilege provision unit 2118 outputs information for offering the gift or awarding the points to the user. In a case where the privilege by the coupon is a discount of a price of a product, the privilege provision unit 2118 subtracts a discount amount by the coupon from the payment amount (the price of the product as a payment target) of the payment information corresponding to the payment token included in the payment request.

The payment execution unit 2119 executes payment by transmitting the payment amount of the payment information corresponding to the payment token included in the payment request (or the payment amount to which the discount by the coupon is applied) to the payment server 24. The payment server 24 executes payment processing in a case where the payment amount received from the privilege provision device 21 is within a balance (for example, a credit balance or a pre-paid balance) payable by the user, and does not execute the payment processing otherwise.

The payment server 24 transmits a payment result indicating whether or not payment is made, to the privilege provision device 21. The payment execution unit 2119 of the privilege provision device 21 receives the payment result from the payment server 24 and notifies the store terminal 23 of the payment result. The reception unit 2313 of the store terminal 23 receives the payment result from the privilege provision device 21 and stores the payment result in the storage unit 232.

The payment execution unit 2119 may calculate a charge for the store that manages the store terminal 23. The charge is a charge that is paid to a payment service provider managing the privilege provision device 21 by the store managing the store terminal 23 to make payment using the privilege provision device 21. The charge is calculated, for example, by multiplying the payment amount by a predetermined coefficient. In this case, in a case where the privilege provision unit 2118 subtracts the discount amount by the coupon from the payment amount (the price of the product as a payment target), the payment execution unit 2119 calculates the charge based on the payment amount after subtraction. On the other hand, in a case where the privilege provision unit 2118 does not subtract the discount amount by the coupon from the payment amount, the payment execution unit 2119 calculates the charge based on the original payment amount. The payment execution unit 2119 outputs information indicating the calculated charge by storing information in the storage unit 212 or transmitting information to the store terminal 23. With this, the privilege provision device 21 can automatically reflect the discount amount by the coupon to correctly calculate the charge that is paid to the payment service provider by the store.

### [Sequence of Payment Method]

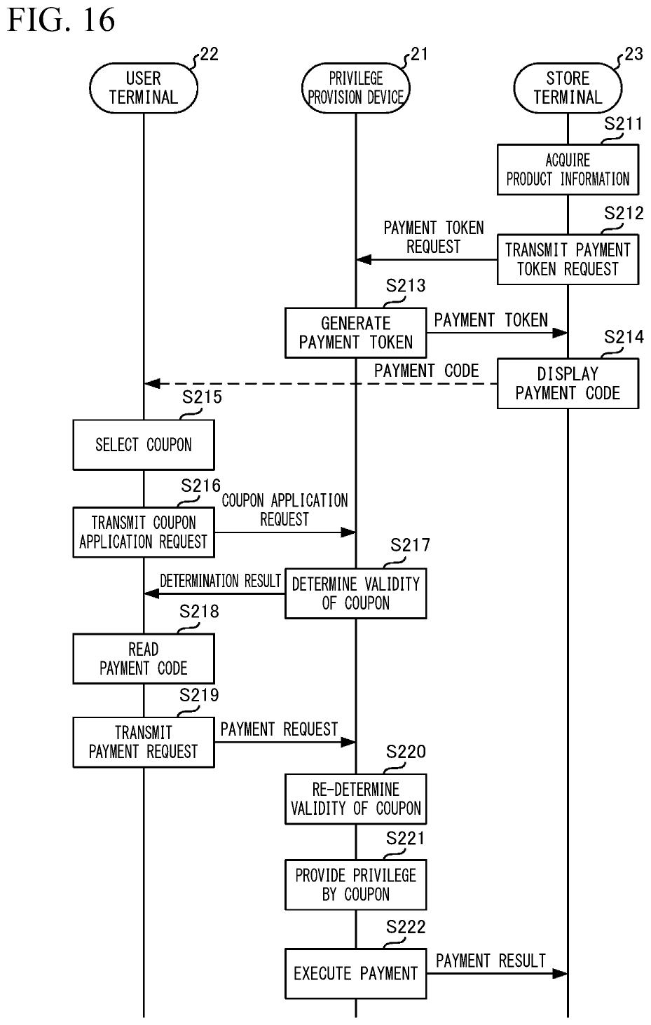

FIG. 16 is a sequence diagram of a payment method (information processing method) that is executed by the payment system 2S according to the second embodiment. In the store terminal 23, the product information acquisition unit 2311 acquires product information including a price of a product that the user wants to purchase (S211). The transmission unit 2312 calculates a payment amount by totaling the price of the product based on the product information acquired by the product information acquisition unit 2311 and transmits a payment token request including payment information indicating the calculated payment amount and the store ID of the store managing the store terminal 23, to the privilege provision device 21 (S212).

In the privilege provision device 21, the payment token request reception unit 2111 receives the payment token request from the store terminal 23. The token generation unit 2112 generate a payment token on a condition that the payment token request reception unit 2111 receives the payment token request (S213). The token generation unit 2112 stores the store ID and the payment information included in the payment token request and the generated payment token in the token storage unit 2122 in association with each other. The token transmission unit 2113 transmits the payment token generated by the token generation unit 2112 to the store terminal 23. The reception unit 2313 of the store terminal 23 generates a payment code by encoding the payment token received from the privilege provision device 21 with a predetermined method. Then, the reception unit 2313 displays the generated payment code on the display unit 233 (S214).

The user terminal 22 receives user's selection of a coupon using the operation unit 223 (S215). The transmission unit 2211 of the user terminal 22 transmits a coupon application request including the user ID associated with the user terminal 22 and the coupon ID associated with the coupon selected by the user, to the privilege provision device 21 (S216). In the privilege provision device 21, the coupon application request reception unit 2114 receives the coupon application request from the user terminal 22. The validity determination unit 2115 specifies the user ID and the coupon ID included in the coupon application request received by the coupon application request reception unit 2114. The validity determination unit 2115 determines whether or not the coupon is valid based on the specified user ID and coupon ID (S217). In a case where determination is made that the coupon is valid, the validity determination unit 2115 stores validity information in which the user ID and the coupon ID are associated with each other, in the validity information storage unit 2123.

The determination result transmission unit 2116 transmits the determination result of the validity determination unit 2115 about the validity of the coupon to the user terminal 22 as a transmission source of the coupon application request. In the user terminal 22, the reception unit 2212 receives the determination result from the privilege provision device 21 and displays the determination result on the display unit 224. The code reading unit 2213 reads the payment code displayed on the store terminal 23 using the imaging unit 225 (S218). The code reading unit 2213 acquires the payment token indicated by the payment code by decoding the read payment code with a predetermined method. The transmission unit 2211 transmits a payment request including the user ID associated with the user terminal 22 and the payment token acquired by the code reading unit 2213, to the privilege provision device 21 (S219).

In the privilege provision device 21, the payment request reception unit 2117 receives the payment request from the user terminal 22. The payment request reception unit 2117 searches for the payment token included in the received payment request from the token storage unit 2122. In a case where the payment token included in the payment request is found on the token storage unit 2122, the payment request reception unit 2117 specifies the store ID and the payment information corresponding to the payment token included in the payment request in the token storage unit 2122. In a case where the payment token included in the received payment request cannot be found on the token storage unit 2122, the payment request reception unit 2117 ends the processing without executing payment.

The payment request reception unit 2117 searches for the user ID included in the received payment request from the validity information storage unit 2123. In a case where the user ID included in the payment request is found on the validity information storage unit 2123, the payment request reception unit 2117 specifies the coupon ID corresponding to the user ID included in the payment request in the validity information storage unit 2123. In a case where the coupon ID corresponding to the user ID included in the payment request cannot be specified, the payment request reception unit 2117 progresses to execution of payment by the payment execution unit 2119 in Step S222 without applying the coupon.

In a case where the payment request reception unit 2117 specifies the store ID, the payment information, and the coupon ID based on the payment request, the validity determination unit 2115 re-determines whether or not the coupon is valid based on the coupon ID corresponding to the user ID included in the payment request (S220). The re-determination of Step S220 may be omitted. In a case where determination is made that the coupon is not valid, the validity determination unit 2115 may end the processing without executing payment or may progress to execution of payment by the payment execution unit 2119 in Step S222 without applying the coupon. In a case where the validity determination unit 2115 determines that the coupon is valid, the privilege provision unit 2118 specifies the privilege included in the coupon information acquired from the coupon storage unit 2121 and associated with the coupon ID corresponding to the user ID included in the payment request and the user ID included in the payment request. Then, the privilege provision unit 2118 provides the user of the user ID included in the payment request with the specified privilege (S221).

The payment execution unit 2119 executes payment by transmitting the payment amount of the payment information corresponding to the payment token included in the payment request (or the payment amount to which the discount by the coupon is applied) to the payment server 24 (S222). The payment server 24 executes payment processing in a case where the payment amount received from the privilege provision device 21 is within a balance (for example, a credit balance or a pre-paid balance) payable by the user and does not execute the payment processing otherwise. The payment server 24 transmits a payment result indicating whether or not payment is made, to the privilege provision device 21. The payment execution unit 2119 of the privilege provision device 21 receives the payment result from the payment server 24 and notifies the store terminal 23 of the payment result. The reception unit 2313 of the store terminal 23 receives the payment result from the privilege provision device 21 and stores the payment result in the storage unit 232.

### Effects of Second Embodiment

With the payment system 2S according to the second embodiment, the privilege provision device 21 stores the user ID and the coupon ID in the validity information storage unit 2123 in association with each other after determining the validity of the coupon when the coupon application request is received from the user terminal 22 and provides the user with the privilege of the coupon on a condition that at least one of the user ID and the coupon ID is stored in the validity information storage unit 2123 when the payment request including at least one of the user ID and the coupon ID is received from the user terminal 22. For this reason, the payment system 2S can reduce a processing burden on the store terminal 23 and does not need costs to improve the processing performance of the store terminal 23. Furthermore, since a manager of the store does not need to register information of the coupon in the store terminal 23, it is possible to reduce a management burden on the manager of the store.

### Fourth Modification Example

The privilege provision device 21 may determine whether or not a coupon is valid based on a product that the user purchases. In this case, the coupon information 2D1 shown in FIG. 12A further includes a product ID (product identification information) for identifying a product as an application target of a coupon. The product ID is identification information unique to each product or identification information allocated to a type (item) of a product. The coupon information 2D1 may include a plurality of product IDs. In regard to a coupon that is available regardless of a product, the product ID is omitted. The token information 2D2 shown in FIG. 12B further includes a product ID of a product as a payment target.

In the store terminal 23, after the product information acquisition unit 2311 acquires the product information, the transmission unit 2312 transmits a payment token request including the payment information including the payment amount, the store ID of the store managing the store terminal 23, and the product ID of the product as a payment target, to the privilege provision device 21. In the privilege provision device 21, the token generation unit 2112 stores the payment information, the store ID, and the product ID included in the payment token request and the generated payment token in the token storage unit 2122 in association with each other.

When the payment request reception unit 2117 receives the payment request from the user terminal 22, the validity determination unit 2115 specifies the product ID corresponding to the payment token included in the payment request, in the token storage unit 2122. Then, the validity determination unit 2115 performs determination using the product ID in addition to the determination using the availability, the term of validity, and the store ID described above. Specifically, the validity determination unit 2115 determines that the coupon is not valid in a case where the product ID corresponding to the payment token included in the payment request is not included in the product ID included in the coupon information.

The validity determination unit 2115 determines that the coupon is valid in a case where the coupon information associated with the user ID and the coupon ID is stored in the coupon storage unit 2121, the availability included in the coupon information indicates that the coupon is available, the current time is within the range of the term of validity included in the coupon information, the store ID included in the payment request is included in the store ID included in the coupon information, and the product ID corresponding to the payment token included in the payment request is included in the product ID included in the coupon information. The validity determination unit 2115 may use only part of the availability, the term of validity, the store ID, and the product ID for the determination. With such a configuration, the privilege provision device 21 can determine the applicability of the coupon based on the product as a payment target.

### Fifth Modification Example

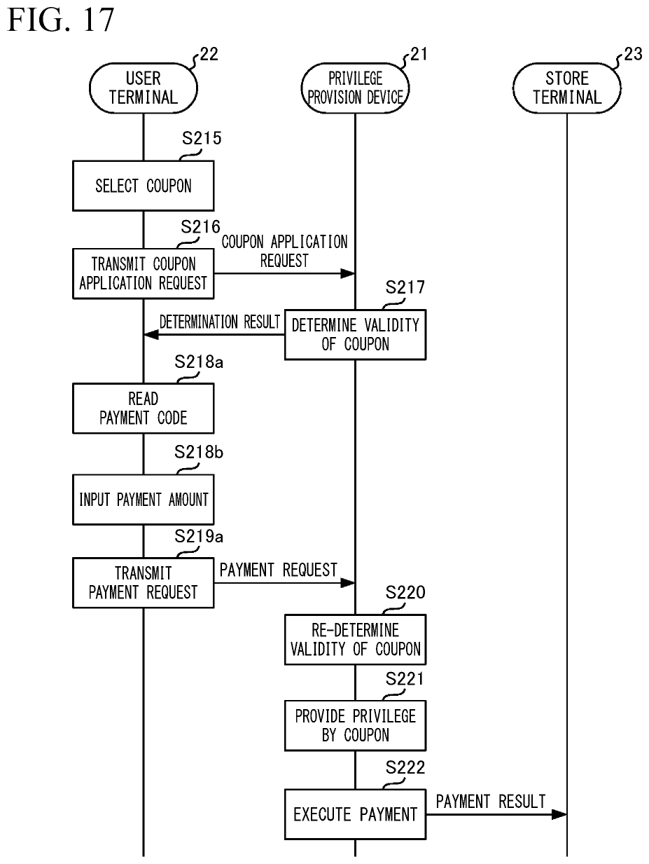

In the above description, although the user terminal 22 makes payment by reading the payment code dynamically generated by the store terminal 23, the user terminal 22 may make payment by reading a static payment code (for example, a printed payment code) presented from the store. FIG. 17 is a sequence diagram of a payment method (information processing method) according to a fifth modification example. In the following description, different points from the sequence diagram of FIG. 16 will be primarily described. In the fifth modification example, the processing before Step S214 is not executed, and the processing of Steps S215 to S217 is the same as in the sequence diagram of FIG. 16.

In the user terminal 22, the reception unit 2212 receives the determination result from the privilege provision device 21 and displays the determination result on the display unit 224. The code reading unit 2213 reads a payment code presented from the store using the imaging unit 225 (S218a). The payment code indicates a payment token that is generated in advance by the privilege provision device 21 and stored in association with the store ID. The code reading unit 2213 acquires the payment token indicated by the payment code by decoding the read payment code with a predetermined method. The code reading unit 2213 displays a screen for inputting a payment amount on the display unit 224 after acquiring the payment token. The user inputs the payment amount on the screen using the operation unit 223 of the user terminal 22.

The payment token may be generated in association with the payment amount in advance in the privilege provision device 21. In this case, an input of the payment amount on the user terminal 22 is not performed. The payment token may be generated in association with the product ID in advance in the privilege provision device 21. With this, the privilege provision device 21 can determine the validity of the coupon using the product ID as in the fourth modification example.

After the user inputs the payment amount, the transmission unit 2211 transmits a payment request including the user ID associated with the user terminal 22, the payment token acquired by the code reading unit 2213, and the payment amount input by the user, to the privilege provision device 21 (S219a). In the privilege provision device 21, the payment request reception unit 2117 receives the payment request from the user terminal 22. The privilege provision device 21 uses the payment amount indicated by the payment request instead of the payment amount stored in the token storage unit 2122 for payment. The processing after Step S220 is the same as in the sequence diagram of FIG. 16. With this, in the fifth modification example, the store terminal 23 does not need to execute processing of dynamically generating a payment code, and the privilege provision device 21 can make payment using the payment amount input by the user.

### Sixth Modification Example

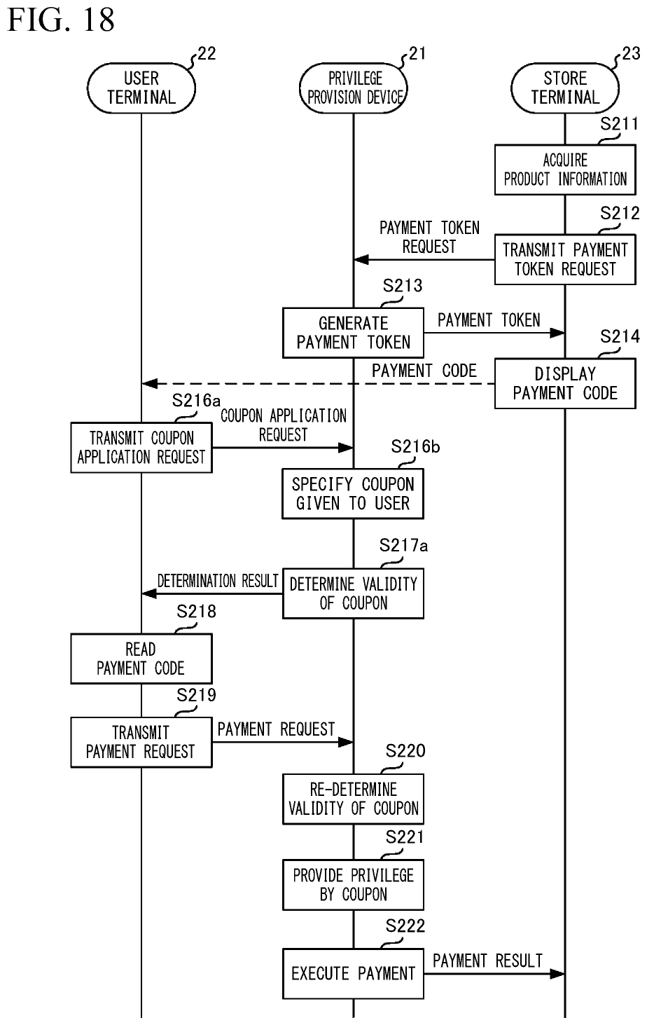

In the above description, although the privilege provision device 21 uses the coupon selected by the user in the user terminal 22 for payment, the privilege provision device 21 may specify a coupon given to the user and may use the coupon for payment. FIG. 18 is a sequence diagram of a payment method (information processing method) according to a sixth modification example. In the following description, different points from the sequence diagram of FIG. 16 will be primarily described. The processing before Step S214 is the same as in the sequence diagram of FIG. 16. In the user terminal 22, the transmission unit 2211 transmits a coupon application request including the user ID associated with the user terminal 22 to the privilege provision device 21 without receiving user's selection of a coupon (S216a).

In the privilege provision device 21, the coupon application request reception unit 2114 receives the coupon application request from the user terminal 22. The validity determination unit 2115 specifies the coupon ID (that is, the coupon given to the user) associated with the user ID included in the coupon application request received by the coupon application request reception unit 2114, in the coupon storage unit 2121 (S216b). In a case where there is the coupon ID associated with the user ID in the coupon storage unit 2121, the validity determination unit 2115 determines whether or not the coupon is valid based on the user ID and the coupon ID (S217a). In a case where there is no coupon ID associated with the user ID in the coupon storage unit 2121 or in a case where the validity determination unit 2115 determines that the coupon is not valid, the determination result transmission unit 2116 transmits a determination result indicating that there is no valid coupon, to the user terminal 22.

In a case where determination is made that the coupon is valid, the validity determination unit 2115 stores validity information in which the user ID and the coupon ID are associated with each other, in the validity information storage unit 2123. Then, the determination result transmission unit 2116 transmits a determination result indicating the coupon information of the valid coupon to the user terminal 22. In the user terminal 22, the reception unit 2212 displays the coupon information indicated by the determination result received from the privilege provision device 21 on the display unit 224. The processing after Step S218 is the same as in the sequence diagram of FIG. 16. In this way, in the payment method according to the sixth modification example, the privilege provision device 21 can specify a coupon given to the user and automatically use the coupon for payment without receiving user's selection of a coupon.

In a case where the reception unit 2212 receives the determination result indicating the coupon information of the valid coupon, the user terminal 22 may receive selection about whether or not to apply the coupon, from the user. In this case, in Step S221, the privilege provision unit 2118 of the privilege provision device 21 provides the user with only the privilege of the coupon that the user selects to apply. With this, the privilege provision device 21 can specify the coupon given to the user, and then, can apply the coupon to payment after receiving selection about whether or not to apply the coupon, from the user.

Although the present invention has been described in connection with the embodiment, the technical scope of the present invention is not limited to the range described in the above-described embodiment, and various modifications and alterations can be made within the scope of the spirit of the present invention. For example, specific embodiments of dispersion or integration of the device are not limited to the above-described embodiment, all or part thereof, can be configured with any unit that is functionally or physically dispersed or integrated. New embodiments generated by any combinations of a plurality of embodiments are also included in the embodiments of the present invention. The effects of the new embodiments generated by the combinations also have the effects of the original embodiment.

The processors of the privilege provision device 21, the user terminal 22, the store terminal 23, and the payment server 24 are the core of each step (process) included in the payment method shown in FIGS. 16 to 18. That is, the processors of the privilege provision device 21, the user terminal 22, the store terminal 23, and the payment server 24 execute the payment method shown in FIGS. 16 to 18 by reading the programs for executing the payment method shown in FIGS. 16 to 18 from the storage unit and executing the programs to control the units of the payment system 2S. The steps included in the payment method shown in FIGS. 16 to 18 may be partially omitted, the order of the steps may be changed, or a plurality of steps may be performed in parallel.

### REFERENCE SIGNS LIST

1S: Payment system
11: Privilege provision device
1111: Payment token request reception unit
1112: Validity determination unit
1113: Token generation unit
1114: Token transmission unit
1115: Payment request reception unit
1116: Privilege provision unit
1117: Payment execution unit
2S: Payment system
21: Privilege provision device
2114: Coupon application request reception unit
2115: Validity determination unit
2117: Payment request reception unit
2118: Privilege provision unit

1. An information processing device comprising:
a first reception unit configured to receive a token request including user identification information from a user terminal used by a user;
a generation unit configured to generate a token associated with coupon identification information associated with a coupon given to the user associated with the user identification information and the user identification information included in the token request;
a transmission unit configured to transmit the token generated by the generation unit to the user terminal;
a second reception unit configured to receive a payment request including the token acquired from the user terminal by a store terminal provided in a store, from the store terminal;
a determination unit configured to determine whether or not the coupon associated with the coupon identification information is valid at the time of the reception of the token request; and
a privilege provision unit configured to provide the user associated with the user identification information corresponding to the token with a privilege by the coupon associated with the coupon identification information corresponding to the token in a case where the determination unit determines that the coupon is valid.

2. The information processing device according to claim 1,
wherein the first reception unit receives the token request including the coupon identification information from the user terminal, and
the determination unit specifies the coupon identification information included in the token request.

3. The information processing device according to claim 1,
wherein the determination unit specifies the coupon identification information associated with the user identification information included in the token request in advance in a storage unit.

4. The information processing device according to claim 3,
wherein the transmission unit transmits information regarding the coupon associated with the coupon identification information specified by the determination unit to the user terminal.

5. The information processing device according to claim 1,
wherein the determination unit determines whether or not the coupon given to the user associated with the user identification information included in the token request is valid when the first reception unit receives the token request.

6. The information processing device according to claim 5,
wherein the determination unit does not determine whether or not the coupon associated with the coupon identification information corresponding to the token included in the payment request is valid when the second reception unit receives the payment request.

7. The information processing device according to claim 5,
wherein the determination unit re-determines whether or not the coupon associated with the coupon identification information corresponding to the token included in the payment request is valid when the second reception unit receives the payment request, and
the privilege provision unit provides the user associated with the user identification information corresponding to the token with a privilege by the coupon associated with the coupon identification information corresponding to the token in a case where the determination unit determines that the coupon is valid both when the first reception unit receives the token request and when the second reception unit receives the payment request.

8. The information processing device according to claim 1,
wherein the determination unit does not determine whether or not the coupon given to the user associated with the user identification information included in the token request is valid when the first reception unit receives the token request and determines whether or not the coupon associated with the coupon identification information corresponding to the token included in the payment request is valid when the second reception unit receives the payment request.

9. The information processing device according to claim 7,
wherein the determination unit determines that the coupon is valid on a condition that store identification information of the store included in the payment request corresponds to the store identification information associated with the coupon identification information.

10. The information processing device according to claim 7,
wherein the determination unit determines that the coupon is valid on a condition that product identification information of a product as a payment target included in the payment request corresponds to the product identification information associated with the coupon identification information.

11. The information processing device according to claim 1, further comprising:
a payment execution unit configured to make payment of a payment amount obtained by subtracting an amount indicated by the privilege decided by the privilege provision unit from a price of a product as a payment target included in the payment request in a case where the determination unit determines that the coupon is valid.

12. The information processing device according to claim 11,
wherein the payment execution unit outputs information indicating a charge for the store based on the payment amount obtained by subtracting the amount indicated by the privilege decided by the privilege provision unit from the price of the product as the payment target included in the payment request in a case where the determination unit determines that the coupon is valid.

13. The information processing device according to claim 1,
wherein the privilege provision unit provides the user with the privilege on a condition that a time when the second reception unit receives the payment request is within a predetermined time from a time when the generation unit generates the token.

14. An information processing method that is executed by a processor, the information processing method comprising:
receiving a token request including user identification information from a user terminal used by a user;
generating a token associated with coupon identification information associated with a coupon given to the user associated with the user identification information and the user identification information included in the token request;
transmitting the token generated in the generating step to the user terminal;
receiving a payment request including the token acquired from the user terminal by a store terminal provided in a store from the store terminal;
determining whether or not the coupon associated with the coupon identification information is valid at the time of the reception of the token request; and
providing the user associated with the user identification information corresponding to the token with a privilege by the coupon associated with the coupon identification information corresponding to the token in a case where determination is made in the determining step that the coupon is valid.

15. The information processing method according to claim 14,
wherein the step of determining includes
a first step of determining whether or not the coupon given to the user associated with the user identification information included in the token request is valid when the token request is received in the step of receiving the token request, and
a second step of re-determining whether or not the coupon associated with the coupon identification information corresponding to the token included in the payment request is valid when the payment request is received in the step of receiving the payment request, and
in the step of providing the privilege, in a case where determination is made in both the first step and the second step that the coupon is valid, the user associated with the user identification information corresponding to the token is provided with the privilege by the coupon associated with the coupon identification information corresponding to the token.

16.-29. (canceled)
